(19) United States
(12) Patent Application Publication
(10) Pub. No.: US 2026/0370822 A1
(43) Pub. Date: Nov. 19, 2026

(54) IMAGE ENCODING/DECODING METHOD, METHOD FOR TRANSMITTING BITSTREAM, AND RECORDING MEDIUM ON WHICH BITSTREAM IS STORED

(71) Applicant: LG ELECTRONICS INC., Seoul (KR)

(72) Inventors: Hyeong Moon JANG, Seoul (KR); Jung Hak NAM, Seoul (KR); Nae Ri PARK, Seoul (KR); Yongjo AHN, Seoul (KR)

(73) Assignee: LG ELECTRONICS INC., Seoul (KR)

(21) Appl. No.: 19/145,693

(22) PCT Filed: Jan. 4, 2024
(86) PCT No.: PCT/KR2024/000171

§ 371 Date: Jul. 3, 2025

(30) Foreign Application Priority Data
Jan. 4, 2023 (KR) 10-2023-0001031

(51) Int. Cl. H04N 19/119; H04N 19/176; H04N 19/70

(52) U.S. Cl. CPC H04N 19/119; H04N 19/176; H04N 19/70

(57) ABSTRACT

An image encoding/decoding method, a bitstream transmission method, and a computer-readable recording medium on which a bitstream is stored are provided. The method by which the image decoding device decodes an image, according to the present disclosure, may comprise the steps of: dividing the current block into three areas on the basis of division information; generating a prediction area for each area on the basis of information for prediction of the three areas; and generating a prediction block for the current block on the basis of the generated prediction areas.

### CROSS-REFERENCE TO RELATED APPLICATION(S)

This application is the National Stage filing under 35 U.S.C. 371 of International Application No. PCT/KR2024/000171, filed on Jan. 4, 2024, which claims the benefit of earlier filing date and right of priority to Korean Application No. 10-2023-0001031, filed on Jan. 4, 2023, the contents of which are all incorporated by reference herein in their entirety.

### TECHNICAL FIELD

The present disclosure relates to an image encoding/decoding method, a method for transmitting a bitstream and a recording medium storing a bitstream, and relates to a method for partitioning and predicting a block into three regions.

### BACKGROUND

Recently, the demand for high-resolution and high-quality images, such as High Definition (HD) images and Ultra High Definition (UHD) images, has been increasing in various fields. As image data becomes high-resolution and high-quality, the amount of transmitted information or bit rate increases relative to conventional image data. The increase in transmitted information or bit rate amount leads to an increase in transmission costs and storage costs.

Accordingly, a high-efficiency image compression technology is required to effectively transmit, store, and reproduce the information of high-resolution and high-quality images.

### SUMMARY

The present disclosure is to provide an image encoding/decoding method and apparatus with improved encoding/decoding efficiency.

In addition, the present disclosure is to propose a TGIP mode that partitions a block into three regions and predicts it.

In addition, the present disclosure is to propose a method for defining one angle and two straight lines used to partition a block into three regions.

In addition, the present disclosure is to propose a method for defining syntaxes for determining whether to allow and apply a TGIP mode.

In addition, the present disclosure is to propose a method for implicitly deriving one angle and two straight lines.

In addition, the present disclosure is to propose a method for deriving a prediction mode for regions.

In addition, the present disclosure is to propose a method for deriving prediction information for regions.

In addition, the present disclosure is to propose a method for deriving the prediction block of a block based on prediction regions that predict regions.

In addition, the present disclosure is to propose a method for storing a prediction mode and prediction information for regions.

In addition, the present disclosure is to provide a non-transitory computer-readable recording medium for storing a bitstream generated by the image encoding method according to the present disclosure.

In addition, the present disclosure is to provide a non-transitory computer-readable recording medium for storing a bitstream which is received and decoded by the image decoding apparatus according to the present disclosure and used for image reconstruction.

In addition, the present disclosure is to provide a method for transmitting a bitstream which is generated by the image encoding method according to the present disclosure.

The technical problems to be achieved in the present disclosure are not limited to the technical problems described above, and other technical problems not described may be clearly understood by those of ordinary skill in the art from the following descriptions.

An image decoding method according to an aspect of the present disclosure, as an image decoding method performed by an image decoding apparatus, may be an image decoding method that includes partitioning a current block into three regions based on partition information; based on information for prediction of the three regions, generating a prediction region for the each region; and based on the generated prediction regions, generating a prediction block for the current block.

An image encoding method according to another aspect of the present disclosure, as an image encoding method performed by an image encoding apparatus, may be an image encoding method that includes partitioning a current block into three regions; based on information for prediction of the three regions, generating a prediction region for the each region; and based on the generated prediction regions, generating a prediction block for the current block.

A computer-readable recording medium according to another aspect of the present disclosure may store a bitstream generated by the image encoding method or device of the present disclosure.

A transmission method according to another aspect of the present disclosure may transmit a bitstream generated by the image encoding method or device of the present disclosure.

The features briefly summarized above for the present disclosure are merely an exemplary aspect of a detailed description of the present disclosure described below, and do not limit the scope of the present disclosure.

According to the present disclosure, an image encoding/decoding method and apparatus with improved encoding/decoding efficiency may be provided.

In addition, according to the present disclosure, since a block partitioned into three regions is predicted in the unit of a region, a more accurate prediction block may be generated.

In addition, according to the present disclosure, since a prediction block is accurately generated, a signaled residual signal may be minimized to refine compression efficiency.

In addition, according to the present disclosure, a non-transitory computer-readable recording medium for storing a bitstream generated by the image encoding method according to the present disclosure may be provided.

According to the present disclosure, a non-transitory computer-readable recording medium for storing a bitstream which is received and decoded by the image decoding apparatus according to the present disclosure and used for image reconstruction may be provided.

According to the present disclosure, a method for transmitting a bitstream generated by the image encoding method may be provided.

The effects obtainable from the present disclosure are not limited to the effects described above, and other effects not described may be clearly understood by those of ordinary skill in the art from the following descriptions.

### BRIEF DESCRIPTION OF THE DRAWINGS

FIG. 1 shows a schematic diagram of a video coding system to which an embodiment according to the present disclosure may be applied.

FIG. 2 shows a schematic diagram of an image encoding apparatus to which an embodiment according to the present disclosure may be applied.

FIG. 3 shows a schematic diagram of an image decoding apparatus to which an embodiment according to the present disclosure may be applied.

FIG. 4 is a diagram showing partition examples of the existing GPM.

FIG. 5 is a diagram showing an example of GPM intra blending.

FIG. 6 is a flowchart showing an image encoding method based on a TGIP mode according to an embodiment of the present disclosure.

FIG. 7 is a flowchart showing an image decoding method based on a TGIP mode according to an embodiment of the present disclosure.

FIG. 8 is a diagram showing examples of the present disclosure in which a block is partitioned into regions in a TGIP mode.

FIG. 9 is a diagram showing examples of the present disclosure for a prediction mode applied to each region in a TGIP mode.

FIG. 10 is a diagram showing an example of the present disclosure in which the prediction block of a block and regions are generated in a TGIP mode.

FIG. 11 is a flowchart showing an image encoding method according to an embodiment of the present disclosure.

FIG. 12 is a flowchart showing an image decoding method according to an embodiment of the present disclosure.

FIG. 13 is a flowchart showing an image encoding method according to an embodiment of the present disclosure.

FIG. 14 is a flowchart showing an image decoding method according to an embodiment of the present disclosure.

FIG. 15 is a flowchart showing an image encoding method according to an embodiment of the present disclosure.

FIG. 16 is a flowchart showing an image decoding method according to an embodiment of the present disclosure.

FIGS. 17 and 18 are a drawing for describing examples of the present disclosure for the angle of TGIP.

FIG. 19 is a drawing for describing examples of the present disclosure for the partition structure of TGIP.

FIG. 20 is a flowchart showing an image encoding method according to an embodiment of the present disclosure.

FIG. 21 is a flowchart showing an image decoding method according to an embodiment of the present disclosure.

FIG. 22 is a flowchart showing an image encoding method according to an embodiment of the present disclosure.

FIG. 23 is a flowchart showing an image decoding method according to an embodiment of the present disclosure.

FIG. 24 is a flowchart showing an image encoding method according to an embodiment of the present disclosure.

FIG. 25 is a flowchart showing an image decoding method according to an embodiment of the present disclosure.

FIG. 26 is a flowchart showing an image encoding method according to an embodiment of the present disclosure.

FIG. 27 is a flowchart showing an image decoding method according to an embodiment of the present disclosure.

FIG. 28 is a flowchart showing an image encoding method according to an embodiment of the present disclosure.

FIG. 29 is a flowchart showing an image decoding method according to an embodiment of the present disclosure.

FIG. 30 is a flowchart showing an image encoding method according to an embodiment of the present disclosure.

FIG. 31 is a flowchart showing an image decoding method according to an embodiment of the present disclosure.

FIG. 32 is a drawing showing an example of the present disclosure for the partition structure and prediction mode of TGIP.

FIG. 33 is a drawing showing an example of the present disclosure for determining the partition structure of TGIP.

FIG. 34 is a drawing showing an example of the present disclosure in which the partition structure of TGIP is determined.

FIGS. 35 to 39 are a drawing showing an example of the present disclosure in which the prediction block of TGIP is generated.

FIG. 40 shows an exemplary diagram of a content streaming system to which an embodiment of the present disclosure may be applied.

### DETAILED DESCRIPTION

Hereinafter, embodiments of the present disclosure will be described in detail by referring to the attached drawings for those of ordinary skill in the art to easily implement them. However, the present disclosure may be implemented in various different forms and is not limited to the embodiments described herein.

In describing embodiments of the present disclosure, detailed explanations of well-known configurations or functions are omitted when they are deemed to obscure the main point of the present disclosure. Additionally, parts irrelevant to the description of the present disclosure are omitted from the drawings, and similar reference numerals have been assigned to similar parts.

In the present disclosure, when a certain component is described as being “connected,” “coupled,” or “linked” to another component, this may include not only a direct connection but also an indirect connection where another component may exist in the middle. Additionally, when a certain component is described as “including” or “having” another component, this means that, unless explicitly stated otherwise, it does not exclude other components but may further include additional components.

In the present disclosure, the terms first, second, etc. are used solely for the purpose of distinguishing one component from another and do not limit the order or importance of the components unless explicitly stated otherwise. Accordingly, a first component in one embodiment may be referred to as a second component in another embodiment, and similarly, a second component in one embodiment may be referred to as a first component in another embodiment within the range of the present disclosure.

In the present disclosure, distinguishable components are described to clearly explain their respective characteristics and do not necessarily mean that the components are separate. In other words, a plurality of components may be integrated into a single hardware or software unit, or a single component may be distributed across multiple hardware or software units. Accordingly, without explicitly describing them, such integrated or distributed embodiments are also included in the range of the present disclosure.

In the present disclosure, the components described in various embodiments do not necessarily mean essential components, and some may be optional components. Accordingly, embodiments composed of a subset of the components described in one embodiment are also included in the range of the present disclosure. Additionally, embodiments that include additional components beyond those described in various embodiments are also included in the range of the present disclosure.

The present disclosure relates to the encoding and decoding of images, and the terms used herein may have the ordinary meanings commonly used in the field of technology to which this disclosure belongs unless the terms are newly defined in the present disclosure.

In the present disclosure, “picture” generally refers to a unit representing a single image at a specific point in time. A slice/tile is an encoding unit that constitutes a part of a picture, and a picture may be composed of one or more slices/tiles. Additionally, a slice/tile may include one or more coding tree units (CTUs).

In the present disclosure, “pixel” or “pel” may refer to the smallest unit that constitutes one picture (or image). Additionally, the term “sample” may be used as a corresponding term for a pixel. A sample may generally represent a pixel or the value of a pixel and may indicate only the pixel/pixel value of a luma component or only the pixel/pixel value of a chroma component.

In the present disclosure, “unit” may refer to a basic unit of image processing. A unit may include at least one of a specific area of a picture or information related to the area. Depending on the context, the term “unit” may be used interchangeably with “sample array,” “block,” “area,” etc. In general, an M×N block may include a set (or array) of samples (or a sample array) or a set (or array) of transform coefficients, consisting of M columns and N rows.

In the present disclosure, the term “current block” may refer to one of “current coding block”, “current coding unit”, “encoding target block”, “decoding target block”, or “processing target block”. When prediction is performed, “current block” may refer to “current prediction block” or “prediction target block”. When transform (inverse transform)/quantization (dequantization) is performed, “current block” may refer to “current transform block” or “transform target block”. When filtering is performed, “current block” may refer to “filtering target block”.

In the present disclosure, unless explicitly stated as a chroma block, the term “current block” may refer to a block that includes both a luma component block and a chroma component block or may refer to “the luma block of the current block”. The luma component block of the current block may be explicitly expressed with terms such as “luma block” or “current luma block”, clearly indicating it as a luma component block. Additionally, the chroma component block of the current block may be explicitly expressed with terms such as “chroma block” or “current chroma block”, clearly indicating it as a chroma component block.

In the present disclosure, “/” and “,” may refer to “and/or”. For example, “A/B” and “A, B” may refer to “A and/or B”. Additionally, “A/B/C” and “A, B, C” may refer to “at least one of A, B, and/or C”.

In the present disclosure, “or” may refer to “and/or”. For example, “A or B” may mean 1) “A” only, 2) “B” only, or 3) “A and B.” Alternatively, in the present disclosure, “or” may also mean “additionally or alternatively”.

### Overview of the Video Coding System

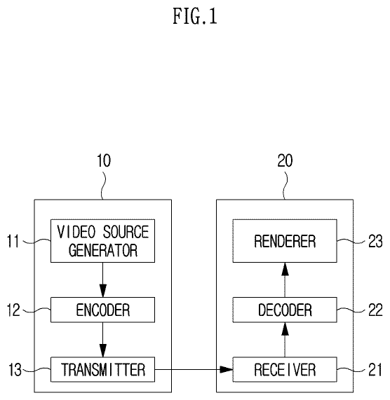

FIG. 1 shows a schematic diagram of a video coding system to which an embodiment according to the present disclosure may be applied.

A video coding system according to an embodiment may include an encoder apparatus 10 and a decoder apparatus 20. The encoder apparatus 10 may transmit encoded video and/or image information or data to the decoder apparatus 20 through a digital storage medium or network in the form of a file or streaming.

An encoder apparatus 10 according to an embodiment may include a video source generator 11, an encoder 12, and a transmitter 13. A decoder apparatus 20 according to an embodiment may include a receiver 21, a decoder 22, and a renderer 23. The encoder 12 may be referred to as a video/image encoder, and the decoder 22 may be referred to as a video/image decoder. The transmitter 13 may be included in the encoder 12. The receiver 21 may be included in the decoder 22. The renderer 23 may include a display, and the display may be configured as a separate device or external component.

The video source generator 11 may obtain a video/an image through a process of capturing, synthesizing, or generating a video/an image. The video source generator 11 may include a video/an image capture device and/or a video/an image generation device. The video/image capture device may include, for example, one or more cameras, a video/an image archive containing previously captured video/image, etc. The video/image generation device includes, for example, a computer, tablet, or smartphone, and may (electronically) generate a video/an image. For example, virtual video/image may be generated through a computer, etc., and in this case, the video/image capturing process may be replaced by the process of generating related data.

The encoder 12 may encode the input video/image. The encoder 12 may perform a series of procedures such as prediction, transform, quantization, etc. for compression and encoding efficiency. The encoder 12 may output the encoded data (encoded video/image information) in the form of a bitstream.

The transmitter 13 may obtain the encoded video/image information or data output in the form of a bitstream and transmit it to the receiver 21 of the decoder apparatus 20 or another external object through a digital storage medium or network, in the form of a file or streaming. The digital storage medium may include various storage media such as USB, SD, CD, DVD, Blu-ray, HDD, SSD, etc. The transmitter 13 may include an element for generating media files through a predetermined file format and element for transmission over broadcast/communication networks. The transmitter 13 may be provided as a separate transmission apparatus from the encoding apparatus 12, in which case the transmission apparatus may include at least one processor for obtaining the encoded video/image information or data in bitstream form and a transmitter for delivering it in the form of file or streaming. The receiver 21 may extract/receive the bitstream from the storage medium or network and transmit it to decoder 22.

The decoder 22 may decode the video/image by performing a series of procedures such as dequantization, inverse transform, prediction, etc. corresponding to the operations of the encoder 12.

The renderer 23 may render the decoded video/image. The rendered video/image may be displayed through the display unit.

### Overview of the Image Encoding Apparatus

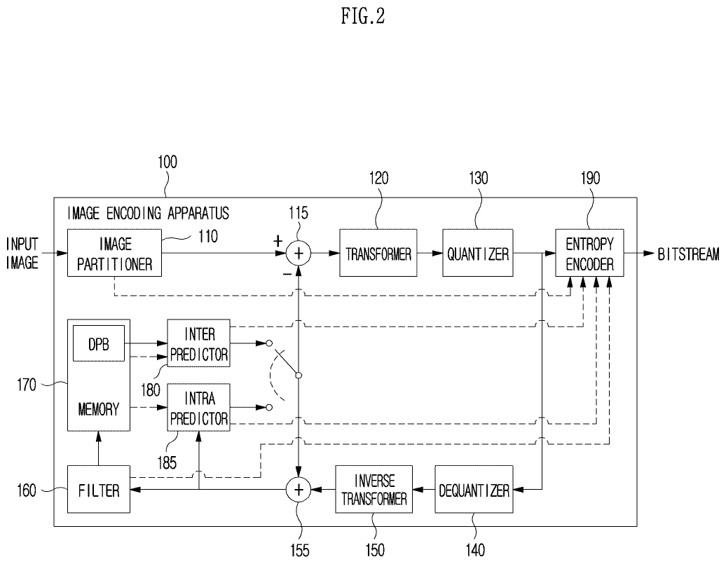

FIG. 2 shows a schematic diagram of an image encoding apparatus to which an embodiment according to the present disclosure may be applied.

As described in FIG. 2, the image encoding apparatus 100 may include an image partitioner 110, a subtractor 115, a transformer 120, a quantizer 130, a dequantizer 140, an inverse transformer 150, an adder 155, a filter 160, a memory 170, an inter predictor 180, an intra predictor 185, and an entropy encoder 190. The inter predictor 180 and the intra predictor 185 may collectively be referred to as a “predictor.” The transformer 120, the quantizer 130, the dequantizer 140, and the inverse transformer 150 may be included in a residual processor. The residual processor may further include the subtractor 115.

All or at least some of the multiple components constituting the image encoding apparatus 100 may be implemented as a single hardware component (i.e., an encoder or a processor), depending on the embodiment. Additionally, the memory 170 may include a decoded picture buffer (DPB) and may be implemented by a digital storage medium.

The image partitioner 110 may partition the input image (or picture, frame) input to the image encoding apparatus 100 into at least one processing unit. As an example, the processing unit may be referred to as a coding unit (CU). A coding unit may be obtained by recursively partitioning a coding tree unit (CTU) or a largest coding unit (LCU) according to a quad-tree, binary-tree, or ternary-tree (QT/BT/TT) structure. For example, a coding unit may be divided into a deeper-depth coding unit based on a quad-tree structure, a binary-tree structure, and/or a ternary-tree structure. For partitioning a coding unit, the quad-tree structure may be applied first, followed by the binary-tree structure and/or the ternary-tree structure. The coding procedure according to the present disclosure may be performed based on the final coding unit, which is not further partitioned. The largest coding unit may be used directly as the final coding unit, or a deeper-depth coding unit obtained by partitioning the largest coding unit may be used as the final coding unit. Here, the coding procedure may include a procedure such as prediction, transform, and/or reconstruction, which will be described later. As another example, the processing unit for the coding procedure may be a prediction unit (PU) or a transform unit (TU). The prediction unit and the transform unit may each be divided or partitioned from the final coding unit. The prediction unit may be a unit for sample prediction, and the transform unit may be a unit for deriving a transform coefficient and/or deriving a residual signal from a transform coefficient.

The predictor (inter predictor 180 or intra predictor 185) may perform prediction for a target block (current block) and generate a predicted block that includes prediction samples for the current block. The predictor may determine whether intra prediction or inter prediction is applied to the current block or coding unit (CU). The predictor may generate various information related to the prediction of the current block and transmit it to the entropy encoder 190. The prediction-related information may be encoded by the entropy encoder 190 and may be output in the form of a bitstream.

The intra predictor 185 may predict the current block by referring to samples within the current picture. The referenced samples may be located in the neighboring area of the current block or may be located farther away, depending on the intra prediction mode and/or intra prediction method. The intra prediction modes may include a plurality of non-directional modes and a plurality of directional modes. The non-directional mode may include, for example, a DC mode and a planar mode. The directional mode may include, for example, 33 directional prediction modes or 65 directional prediction modes, depending on the granularity of the prediction direction. However, this is an example, and a greater or fewer number of directional prediction modes may be used depending on the configuration. The intra predictor 185 may also determine the prediction mode applied to the current block by using the prediction mode applied to neighboring block.

The inter predictor 180 may derive a predicted block for the current block based on a reference block (reference sample array) specified by a motion vector on a reference picture. To reduce the amount of motion information transmitted in the inter prediction mode, motion information may be predicted at the block, sub-block, or sample level based on the correlation of motion information between the neighboring block and the current block. The motion information may include a motion vector and a reference picture index. The motion information may further include information on the inter prediction direction (i.e. L0 prediction, L1 prediction, Bi prediction, etc.). In inter prediction, neighboring block may include spatial neighboring block present within the current picture and temporal neighboring block present in the reference picture. The reference picture containing the reference block and the reference picture containing the temporal neighboring block may be the same or different. The temporal neighboring block may be referred to as a collocated reference block or a collocated coding unit (colCU). The reference picture containing the temporal neighboring block may be referred to as a collocated picture (colPic). For example, the inter predictor 180 may construct a motion information candidate list based on neighboring blocks and generate information indicating which candidate is used to derive the motion vector and/or reference picture index of the current block. Inter prediction may be performed based on various prediction modes, and for example, in the skip mode and merge mode, the inter predictor 180 may use the motion information of neighboring block as the motion information of the current block. In skip mode, unlike merge mode, residual signal may not be transmitted. In the motion vector prediction (MVP) mode, the motion vector of a neighboring block may be used as a motion vector predictor, and the motion vector of the current block may be signaled by encoding the motion vector difference and an indicator for the motion vector predictor. The motion vector difference may refer to the difference between the motion vector of the current block and the motion vector predictor.

The predictor may generate a prediction signal based on various prediction methods and/or prediction techniques described later. For example, the predictor may apply intra prediction or inter prediction for the prediction of the current block, and it may also apply both intra prediction and inter prediction simultaneously. The prediction method that applies intra prediction and inter prediction simultaneously for the prediction of the current block may be referred to as combined inter and intra prediction (CIIP). Additionally, the predictor may perform intra block copy (IBC) for the prediction of the current block. Intra block copy may be used, for example, for screen content coding (SCC), etc. in applications such as game content image/video coding. IBC is a method of predicting the current block by using a pre-reconstructed reference block within the current picture, located at a predetermined distance from the current block. When IBC is applied, the position of the reference block within the current picture may be encoded as a vector (block vector) corresponding to the predetermined distance. IBC basically performs prediction within the current picture, but since it derives a reference block within the current picture, it may operate similarly to inter prediction. In other words, IBC may use at least one of the inter prediction methods described in the present disclosure.

The prediction signal generated by the predictor may be used to generate a reconstructed signal or to generate a residual signal. The subtractor 115 may generate a residual signal (residual block, residual sample array) by subtracting the prediction signal (predicted block, predicted sample array) output from the predictor from the input image signal (original block, original sample array). The generated residual signal may be transmitted to the transformer 120.

The transformer 120 may generate transform coefficients by applying a transform method to the residual signal. For example, the transform method may include at least one of Discrete Cosine Transform (DCT), Discrete Sine Transform (DST), Karhunen-Loeve Transform (KLT), Graph-Based Transform (GBT), or Conditionally Non-linear Transform (CNT). Here, GBT refers to a transform obtained from a graph when the relationship information between pixels is represented as a graph. CNT refers to a transform obtained based on a prediction signal generated by using all previously reconstructed pixels. The transform process may be applied to a pixel block of the same square size or to a non-square variable-sized block.

The quantizer 130 may quantize the transform coefficients and transmit them to the entropy encoder 190. The entropy encoder 190 may encode the quantized signal (information on the quantized transform coefficients) and output it as a bitstream. The information on the quantized transform coefficients may be referred to as residual information. The quantizer 130 may rearrange the block-shaped quantized transform coefficients into a one-dimensional vector based on a coefficient scan order and may generate the information on the quantized transform coefficients based on the one-dimensional vector of quantized transform coefficients.

The entropy encoder 190 may perform various encoding methods, such as exponential Golomb, context-adaptive variable length coding (CAVLC), or context-adaptive binary arithmetic coding (CABAC). The entropy encoder 190 may encode not only the quantized transform coefficients but also information necessary for video/image reconstruction (i.e., values of syntax elements) either together or separately with the quantized transform coefficients. The encoded information (i.e., encoded video/image information) may be transmitted or stored in the form of a bitstream in network abstraction layer (NAL) unit. The video/image information may further include information on various parameter sets, such as an adaptation parameter set (APS), a picture parameter set (PPS), a sequence parameter set (SPS), or a video parameter set (VPS). Additionally, the video/image information may further include general constraint information. The signaling information, transmitted information, and/or syntax elements described in the present disclosure may be included in the bitstream by being encoded through the above-described encoding process.

The bitstream may be transmitted through a network or stored in a digital storage medium. Here, the network may include a broadcast network and/or a communication network, etc., and the digital storage medium may include various storage media such as USB, SD, CD, DVD, Blu-ray, HDD, SSD, etc. A transmitter (not shown) for transmitting the signal output from the entropy encoder 190 and/or a storage unit (not shown) for storing the signal may be provided as an internal/external element of the image encoding apparatus 100, or the transmitter may be configured as a component of the entropy encoder 190.

The quantized transform coefficients output from the quantizer 130 may be used to generate a residual signal. For example, a residual signal (residual block or residual samples) may be reconstructed by applying dequantization and inverse transform to the quantized transform coefficients through the dequantizer 140 and the inverse transformer 150.

The adder 155 may generate a reconstructed signal (reconstructed picture, reconstructed block, or reconstructed sample array) by adding the reconstructed residual signal to the prediction signal output from the inter predictor 180 or the intra predictor 185. When there is no residual for the target block, such as when the skip mode is applied, the predicted block may be used as the reconstructed block. The adder 155 may be referred to as a reconstructor or a reconstructed block generator. The generated reconstructed signal may be used for intra prediction of the next target block within the current picture and, as described later, may also be used for inter prediction of the next picture after undergoing filtering.

The filter 160 may apply filtering to the reconstructed signal to enhance subjective/objective quality. For example, the filter 160 may apply various filtering methods to the reconstructed picture to generate a modified reconstructed picture, and the modified reconstructed picture may be stored in the memory 170, specifically in the DPB of the memory 170. The various filtering methods may include, for example, deblocking filtering, sample adaptive offset, adaptive loop filter, bilateral filter, etc. The filter 160 may generate various filtering-related information, as described later in the explanations of each filtering method, and may transmit it to the entropy encoder 190. The filtering-related information may be encoded by the entropy encoder 190 and output in the form of a bitstream.

The modified reconstructed picture transmitted to the memory 170 may be used as a reference picture in the inter predictor 180. When inter prediction is applied in this case, the image encoding apparatus 100 may avoid prediction mismatches between the image encoding apparatus 100 and the image decoding apparatus, and may improve encoding efficiency.

The DPB in the memory 170 may store the modified reconstructed picture for use as a reference picture in the inter predictor 180. The memory 170 may store the motion information of a block in the current picture where motion information has been derived (or encoded) and/or the motion information of blocks in already reconstructed pictures. The stored motion information may be transmitted to the inter predictor 180 for use as motion information of spatial neighboring block or temporal neighboring block. The memory 170 may store the reconstructed samples of reconstructed blocks in the current picture and transmit them to the intra predictor 185.

### Overview of the Image Decoding Apparatus

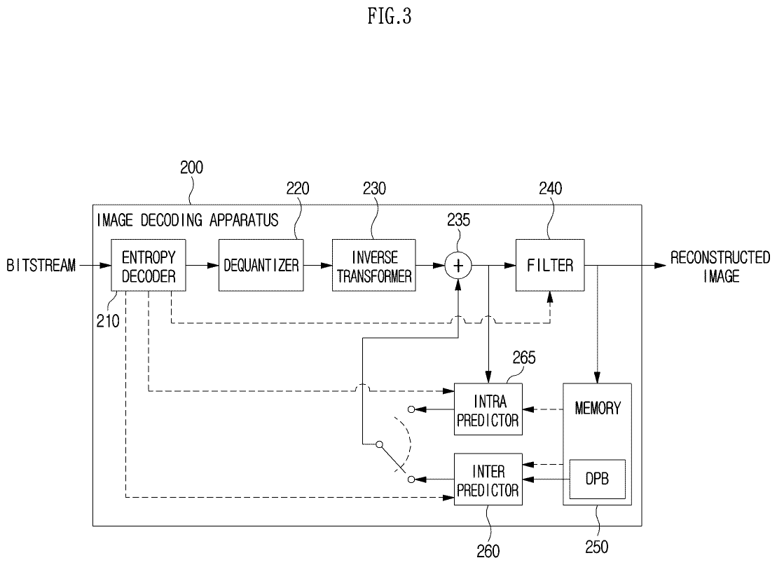

FIG. 3 shows a schematic diagram of an image decoding apparatus to which an embodiment according to the present disclosure may be applied.

As shown in FIG. 3, the image decoding apparatus 200 may include an entropy decoder 210, a dequantizer 220, an inverse transformer 230, an adder 235, a filter 240, a memory 250, an inter predictor 260, and an intra predictor 265. The inter predictor 260 and the intra predictor 265 may collectively be referred to as a “predictor”. The dequantizer 220 and the inverse transformer 230 may be included in a residual processor.

All or at least some of the multiple components constituting the image decoding apparatus 200 may be implemented as a single hardware component (i.e., a decoder or a processor), depending on the embodiment. Additionally, the memory 170 may include a DPB and may be implemented by a digital storage medium.

The image decoding apparatus 200, which receives a bitstream containing video/image information, may perform a process corresponding to the process performed by the image encoding apparatus 100 in FIG. 2 to reconstruct the image. For example, the image decoding apparatus 200 may perform decoding using the processing unit applied in the image encoding apparatus. Therefore, the processing unit for decoding may be, for example, a coding unit. The coding unit may be a coding tree unit or may be obtained by splitting a largest coding unit. Additionally, the reconstructed image signal decoded and output through the image decoding apparatus 200 may be played back through a playback device (not shown).

The image decoding apparatus 200 may receive a signal output from the image encoding apparatus in FIG. 2 in the form of a bitstream. The received signal may be decoded through the entropy decoder 210. For example, the entropy decoder 210 may parse the bitstream to extract the information necessary for image reconstruction (or picture reconstruction) (i.e., video/image information). The video/image information may further include information on various parameter sets, such as an adaptation parameter set (APS), a picture parameter set (PPS), a sequence parameter set (SPS), or a video parameter set (VPS). Additionally, the video/image information may further include general constraint information. The image decoding apparatus may additionally use information on the parameter set and/or the general constraint information to decode the image. The signaling information, received information, and/or syntax elements described in the present disclosure may be obtained from the bitstream by being decoded through the decoding process. For example, the entropy decoder 210 may decode the information in the bitstream based on coding methods such as exponential Golomb encoding, CAVLC, or CABAC, and may output a syntax element value necessary for image reconstruction and quantized values of a transform coefficient related to a residual. More specifically, the CABAC entropy decoding method may receive a bin corresponding to a syntax element in the bitstream, may determine a context model using the information of the decoding target syntax element, the decoding information of neighboring block and the decoding target block, or information of previously decoded symbol/bin, may predict the probability of bin occurrence according to the determined context model, and may perform arithmetic decoding of the bin to generate a symbol corresponding to each syntax element. In this case, the CABAC entropy decoding method may update the context model for the next symbol/bin context model using the decoded symbol/bin information after determining the context model. Among the decoded information from the entropy decoder 210, the prediction-related information may be provided to the predictor (inter predictor 260 and intra predictor 265), and the residual value which is entropy decoded by the entropy decoder 210, in other words, the quantized transform coefficients and related parameter information, may be input to the dequantizer 220. Additionally, among the decoded information from the entropy decoder 210, filtering-related information may be provided to the filter 240. Meanwhile, a receiver (not shown) that receives the signal output from the image encoding apparatus may be additionally configured as an internal/external element of the image decoding apparatus 200, or the receiver may be configured as a component of the entropy decoder 210.

Meanwhile, the image decoding apparatus according to the present disclosure may also be referred to as a video/image/picture decoding apparatus. The image decoding apparatus may include an information decoder (video/image/picture information decoder) and/or a sample decoder (video/image/picture sample decoder). The information decoder may include the entropy decoder 210, and the sample decoder may include at least one of the dequantizer 220, the inverse transformer 230, the adder 235, the filter 240, the memory 250, the inter predictor 260, or the intra predictor 265.

The dequantizer 220 may dequantize the quantized transform coefficients and output the transform coefficients. The dequantizer 220 may rearrange the quantized transform coefficients into a two-dimensional block. In this case, the rearrangement may be performed based on the coefficient scan order applied in the image encoding apparatus. The dequantizer 220 may perform dequantization on the quantized transform coefficients using quantization parameter (i.e., quantization step size information) and may obtain transform coefficients.

The inverse transformer 230 may perform an inverse transform on the transform coefficients to obtain a residual signal (residual block, or residual sample array).

The predictor may perform prediction for the current block and generate a predicted block that includes prediction samples for the current block. The predictor may determine whether intra prediction or inter prediction is applied to the current block based on the prediction-related information output from the entropy decoder 210 and may determine a specific intra/inter prediction mode (prediction method).

That the predictor may generate a prediction signal based on various prediction methods (techniques) which will be described later is the same as described in the explanation of the predictor in the image encoding apparatus 100.

The intra predictor 265 may predict the current block by referring to samples within the current picture. The explanation of the intra predictor 185 may also be applied in the same way to the intra predictor 265.

The inter predictor 260 may derive a predicted block for the current block based on a reference block (reference sample array) specified by a motion vector on a reference picture. In this case, to reduce the amount of motion information transmitted in the inter prediction mode, motion information may be predicted at the block, sub-block, or sample level based on the correlation of motion information between the neighboring block and the current block. The motion information may include a motion vector and a reference picture index. The motion information may further include information on the inter prediction direction (i.e., L0 prediction, L1 prediction, Bi prediction, etc.). In inter prediction, a neighboring block may include spatial neighboring block within the current picture and temporal neighboring block in the reference picture. For example, the inter predictor 260 may construct a motion information candidate list based on neighboring blocks and derive the motion vector and/or reference picture index of the current block based on the received candidate selection information. Inter prediction may be performed based on various prediction modes (methods), and the prediction-related information may include information indicating the inter prediction mode (method) applied to the current block.

The adder 235 may generate a reconstructed signal (reconstructed picture, reconstructed block, reconstructed sample array) by adding the obtained residual signal to the prediction signal (predicted block, predicted sample array) output from the predictor (including the inter predictor 260 and/or the intra predictor 265). When there is no residual for the target block, such as when the skip mode is applied, the predicted block may be used as the reconstructed block. The explanation of the adder 155 may also be applied in the same way to the adder 235. The adder 235 may be referred to as a reconstructor or a reconstructed block generator. The generated reconstructed signal may be used for intra prediction of the next target block within the current picture and as described later, may also be used for inter prediction of the next picture after undergoing filtering.

The filter 240 may apply filtering to the reconstructed signal to enhance subjective/objective quality. For example, the filter 240 may apply various filtering methods to the reconstructed picture to generate a modified reconstructed picture, and the modified reconstructed picture may be stored in the memory 250, specifically in the DPB of the memory 250. The various filtering methods may include, for example, deblocking filtering, sample adaptive offset, adaptive loop filter, bilateral filter, etc.

The (modified) reconstructed picture stored in the DPB of the memory 250 may be used as a reference picture in the inter predictor 260. The memory 250 may store the motion information of a block in the current picture where motion information has been derived (or decoded) and/or the motion information of blocks in already reconstructed picture. The stored motion information may be transmitted to the inter predictor 260 to be used as motion information of a spatial neighboring block or a temporal neighboring block. The memory 250 may store the reconstructed samples of reconstructed blocks in the current picture and transmit them to the intra predictor 265.

In this specification, the embodiments described for the filter 160, the inter predictor 180, and the intra predictor 185 of the image encoding apparatus 100 may be applied in the same or corresponding manner to the filter 240, the inter predictor 260, and the intra predictor 265 of the image decoding apparatus 200.

### Inter Prediction

The predictor of an image encoding apparatus 100 and an image decoding apparatus 200 may perform inter prediction in the unit of a block to derive a prediction sample. Inter prediction can be a prediction derived in a manner that is dependent on data elements (e.g., sample values or motion information) of picture(s) other than the current picture. When inter prediction is applied to a current block, a predicted block (a prediction sample array) for a current block may be derived based on a reference block (a reference sample array) specified by a motion vector on a reference picture indicated by a reference picture index. In this case, in order to reduce the amount of motion information transmitted in an inter prediction mode, the motion information of a current block may be predicted in the unit of a block, a sub-block or a sample based on the correlation of motion information between a neighboring block and a current block. The motion information may include a motion vector and a reference picture index. The motion information may further include information on an inter prediction type (L0 prediction, L1 prediction, Bi prediction, etc.). When inter prediction is applied, a neighboring block may include a spatial neighboring block existing in a current picture and a temporal neighboring block existing in a reference picture. A reference picture including the reference block and a reference picture including the temporal neighboring block may be the same or different. The temporal neighboring block may be called a collocated reference block, a collocated CU (colCU), etc., and a reference picture including the temporal neighboring block may be called a collocated picture (colPic). For example, a motion information candidate list may be configured based on the neighboring blocks of a current block, and flag or index information indicating which candidate is selected (used) to derive the motion vector and/or reference picture index of the current block may be signaled. Inter prediction may be performed based on various prediction modes, and for example, for a skip mode and a merge mode, the motion information of a current block may be the same as the motion information of a selected neighboring block. For a skip mode, unlike a merge mode, a residual signal may not be transmitted. For a motion vector prediction (MVP) mode, the motion vector of a selected neighboring block may be used as a motion vector predictor, and a motion vector difference may be signaled. In this case, the motion vector of the current block may be derived by using the sum of the motion vector predictor and the motion vector difference. A MVP mode may also be called an advanced motion vector prediction (AMVP) mode.

The motion information may include L0 motion information and/or L1 motion information according to an inter prediction type (L0 prediction, L1 prediction, Bi prediction, etc.). A motion vector in a L0 direction may be called a L0 motion vector or MVL0, and a motion vector in a L1 direction may be called a L1 motion vector or MVL1. Prediction based on a L0 motion vector may be called L0 prediction, prediction based on a L1 motion vector may be called L1 prediction, and prediction based on both the L0 motion vector and the L1 motion vector may be called Bi prediction. Here, a L0 motion vector may represent a motion vector associated with reference picture list L0 (L0), and a L1 motion vector may represent a motion vector associated with reference picture list L1 (L1). Reference picture list L0 may include pictures preceding the current picture in output order as reference pictures, and reference picture list L1 may include pictures following the current picture in output order. The previous pictures may be called a forward (reference) picture, and the subsequent pictures may be called a backward (reference) picture. The reference picture list L0 may further include pictures following the current picture in output order as reference pictures. In this case, the previous pictures may be indexed first and the subsequent pictures may be indexed next within the reference picture list L0. The reference picture list L1 may further include pictures preceding the current picture in output order as reference pictures. In this case, the subsequent pictures may be indexed first and the previous pictures may be indexed next within the reference picture list 1. Here, output order may correspond to picture order count (POC) order.

### Template Matching (TM)

Template Matching (TM) is a method for deriving a motion vector performed on a decoder side, which is a method for refining the motion information of a current block by finding a template (hereinafter, referred to as a “reference template”) in a reference picture that is most similar to a template (hereinafter, referred to as a “current template”) adjacent to a current block (e.g., current coding unit, current CU). A current template may be the top neighbor block and/or the left neighbor block of a current block or a part of their neighbor block. In addition, a reference template may be determined to have the same size as a current template.

When the initial motion vector of a current block is derived, a search for a better motion vector may be performed in the neighboring region of an initial motion vector. For example, the range of a neighboring region where the search is performed may be within a [−8, +8]-pel search range based on an initial motion vector. In addition, the size of a search step for performing a search may be determined based on the AMVR mode of a current block. In addition, template matching may be performed continuously with a bilateral matching process in a merge mode.

When the prediction mode of a current block is an AMVP mode, a motion vector predictor candidate (MVP candidate) may be determined based on a template matching error. For example, a motion vector predictor candidate (MVP candidate) that minimizes an error between a current template and a reference template may be selected. Afterwards, template matching for refining a motion vector may be performed on the selected motion vector predictor candidate. In this case, template matching for refining a motion vector may not be performed on a motion vector predictor candidate that is not selected.

More specifically, refinement for the selected motion vector predictor candidate may start from full-pel (integer-pel) accuracy within a [−8, +8]-pel search range by using an iterative diamond search. Alternatively, for a 4-pel AMVR mode, it may start from 4-pel accuracy. Afterwards, a search for half-pel and/or quarter-pel accuracy may be followed according to an AMVR mode. According to the search process, a motion vector predictor candidate may maintain the same motion vector accuracy as indicated by an AMVR mode even after a template matching process. In the iterative search process, when a difference between a previous minimum cost and a current minimum cost is less than an arbitrary threshold value, the search process is terminated. The threshold value may be the same as the region of a block, i.e., the number of samples in a block. Table 1 is an example of a search pattern according to an AMVR mode and a merge mode with AMVR.

TABLE 1

| | AMVR mode | | | | | |
|---|---|---|---|---|---|---|
| | 4- | Full- | Half- | Quarter- | Merge mode | |
| Search pattern | pel | pel | pel | pel | AltIF = 0 | AltIF = 1 |
| 4-pel diamond | v | | | | | |
| 4-pel cross | v | | | | | |
| Full-pel | | v | v | v | v | v |
| diamond | | | | | | |
| Full-pel cross | | v | v | v | v | v |
| Half-pel cross | | | v | v | v | v |
| Quarter-pel | | | | v | v | |
| cross | | | | | | |
| 1/8-pel cross | | | | | v | |

When the prediction mode of a current block is a merge mode, a similar search method may be applied to a merge candidate indicated by a merge index. As shown in Table 1 above, template matching may be performed up to ⅛-pel accuracy or may skip half-pel accuracy or lower, which may be determined depending on whether an alternative interpolation filter is used according to merge motion information. In this case, the alternative interpolation filter may be a filter used when AMVR is a half-pel mode. In addition, when template matching is available, the template matching may operate as an independent process according to whether bilateral matching (BM) is available, or may operate as an additional motion vector refinement process between block-based bilateral matching and sub-block-based bilateral matching. Whether the template matching is available and/or whether bilateral matching is available may be determined according to checking availability conditions. In the above, the accuracy of a motion vector may mean the accuracy of a motion vector difference (MVD).

### Geometry Partitioning Mode (GPM)

A GPM may be supported for inter prediction. A GPM may be signaled as one type of merge mode by using a CU level flag along with other merge modes such as a regular merge mode, a merge mode with MVD (MMVD) mode, a CIIP mode, a sub-block merge mode, etc. A GPM may support a total of 64 partitions for m,n∈{3 . . . 6} in each possible CU size w×h=2^{m}×2ⁿ excluding 8×64 and 64×8.

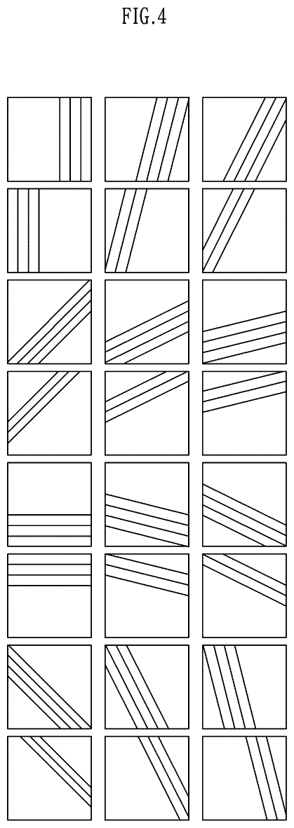

When a GPM is used, a CU may be partitioned into two parts by a geometrically located straight line (a partition line) as shown in FIG. 4. The position of a partition line may be mathematically derived from the angle and offset parameters of specific partition. Each part of geometric partition within a CU may be inter-predicted by using its motion, and only unidirectional prediction is allowed for each partition. In other words, each part may have one motion vector and one reference index. Since unidirectional prediction constraint is applied, only two motion compensation predictions may be required for each CU, similar to the existing bidirectional prediction.

When a GPM is used for a current CU, a geometric partition index (a GPM index) representing the partition mode (angle and offset) of a geometric partition and two merge indexes for partitions may be signaled. The maximum number of GPM candidate sizes is explicitly signaled in a SPS, which may represent syntax binarization for GPM merge indexes.

### Geometry Partitioning Intra Blending Mode (GPM Intra Blending)

In the existing GPM, syntaxes in Table 2 may be signaled, and based on a signaled GPM index, an angle and a distance may be derived by using Table 3, and one block may be partitioned into two arbitrary regions based on an angle and a distance. The prediction block of each region may be generated by using different motion prediction information, and prediction may be performed by blending generated prediction blocks and using them as the prediction block of a corresponding block.

TABLE 2

| | |
|---|---|
| merge_gpm_partition_idx[ x0 ][ y0 ] | ae(v) |
| merge_gpm_idx0[ x0 ][ y0 ] | ae(v) |
| if( MaxNumGpmMergeCand > 2 ) | |
| merge_gpm_idx1[ x0 ][ y0 ] | ae(v) |

TABLE 3

| merge_gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 15 |
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_gpm_ | | | | | | | | | | | | | | | | |
| partition_idx | 16 | 17 | 18 | 19 | 20 | 21 | 22 | 23 | 24 | 25 | 26 | 27 | 28 | 29 | 30 | 31 |
| angleidx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_gpm_ | | | | | | | | | | | | | | | | |
| partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 3 | 3 | 1 | 3 | 1 | 2 | 3 | 1 | 2 | 3 | 1 | 2 | 3 | 1 |
| merge_gpm_ | | | | | | | | | | | | | | | | |
| partition_idx | 48 | 49 | 50 | 31 | 52 | 53 | 34 | 55 | 56 | 37 | 58 | 59 | 60 | 61 | 62 | 63 |
| angleIdx | 21 | 21 | 24 | 24 | 27 | 27 | 27 | 28 | 28 | 28 | 28 | 29 | 29 | 30 | 30 | 30 |
| distanceIdx | 2 | 3 | 1 | 3 | 1 | 2 | 3 | 1 | 3 | 3 | 1 | 2 | 3 | 1 | 2 | 3 |

The existing GPM method used only inter prediction to generate the prediction block of each of the two regions.

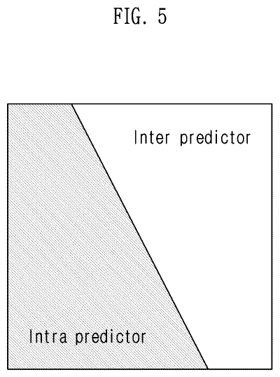

However, a GPM intra blending method may utilize intra prediction to generate the prediction block of each region. FIG. 5 is an example of a prediction block generated by a GPM intra blending method, and a prediction block may be generated by an intra prediction method for at least one of the two regions.

### Intra Block Copy (IBC)

IBC may be used for content image/video coding including games, etc. such as, for example, screen content coding (SCC), etc. IBC basically performs prediction within a current picture, but may be performed in a similar way to inter prediction in that it derives a reference block within a current picture. In other words, IBC may use at least one of the inter prediction techniques described in the present disclosure. For example, IBC may use at least one of the methods for deriving motion information (a motion vector). IBC may refer to a current picture, and accordingly, may be called current picture referencing (CPR).

For IBC, an encoding apparatus may perform block matching (BM) to derive an optimal block vector (or motion vector) for a current block (ex. CU). The derived block vector (or motion vector) may be signaled to a decoding apparatus through a bitstream by using a method similar to block information (motion vector) signaling in the above-described inter prediction. A decoding apparatus may derive a reference block for the current block within a current picture through the signaled block vector (motion vector), through which it may derive a prediction signal (a predicted block or prediction samples) for the current block. Here, the block vector (or motion vector) may represent displacement from a current block to a reference block located in a region that is already reconstructed in a current picture. Accordingly, the block vector (or motion vector) may also be called a displacement vector. Hereinafter, in IBC, the motion vector may correspond to the block vector or the displacement vector. The motion vector of a current block may include a motion vector for a luma component (a luma motion vector) or a motion vector for a chroma component (a chroma motion vector). For example, a luma motion vector for an IBC-coded CU may be an integer sample unit (i.e., integer precision). A chroma motion vector may also be clipped in an integer sample unit. As described above, IBC may use at least one of the inter prediction techniques, and for example, when IBC is applied like AMVR, 1-pel and 4-pel motion vector precision may be switched.

In order to reduce memory consumption and the complexity of a decoder, only the reconstructed part of a predefined region including a current CTU may be used. This constraint may allow an IBC mode to be implemented by using local on-chip memory for hardware implementation.

On an encoder side, hash-based motion estimation may be performed for IBC. An encoder may perform RD check for a block whose width or height is not greater than 16 luma samples. For a non-merge mode, a block vector search may be performed by using a hash-based search first. When a valid candidate is not returned in a hash search, a block matching-based local search may be performed.

In a hash-based search, hash key matching (32-bit CRC) between a current block and a reference block may be extended to all allowed block sizes. The hash key calculation for all positions in a current picture may be based on a 4×4 lower block. For a larger current block, a hash key may be determined to ensure that when the hash key of all 4×4 sub-blocks matches a hash key at a corresponding reference position, it matches the hash key of a reference block. When the hash key of multiple reference blocks matches the hash key of a current block, the block vector cost of each matching reference may be calculated, and the one with the minimum cost may be selected.

In a block matching search, a search range may be set as N samples on the left and top of a current block in a current CTU. At the start of a CTU, the value of N may be initialized to 128 when a temporal reference picture does not exist, or may be initialized to 64 when at least one temporal reference picture exists. A hash hit ratio may be defined as the sample ratio of a CTU that finds a match by using a hash-based search. When a hash hit ratio is less than 5% while encoding a current CTU, N may be reduced by half.

At a CU level, an IBC mode may be signaled by using a flag, and it may be signaled in an IBC AMVP mode or an IBC skip/merge mode as follows.

IBC skip/merge mode: It may be used to represent a block vector used to predict a current block among the block vectors existing in the list of adjacent candidate IBC coding blocks. The merge list may consist of spatial, HMVP and pairwise candidates.

IBC AMVP mode: A block vector difference may be coded in the same way as a motion vector difference. A block vector prediction method uses two candidates as a predictor, one of which may be used as a predictor in the left neighbor and the other from the top neighbor (if IBC coded). When one of the two neighbors is not available, a default block vector may be used as a predictor. A flag representing a block vector predictor index may be signaled.

### Intra Prediction

Intra prediction may refer to a prediction method which generates prediction samples for the current block based on reference samples within the picture to which the current block belongs (the current picture). When intra prediction is applied to the current block, neighboring reference samples to be used for intra prediction of the current block may be derived. The neighboring reference samples of the current block may include a total of 2×nH samples adjacent to the left boundary and neighboring the bottom-left of the current block of nW×nH size, a total of 2×nW samples adjacent to the top boundary and neighboring the top-right of the current block, and one sample neighboring the top-left of the current block. Alternatively, the neighboring reference samples of the current block may include top neighboring samples of multiple columns and left neighboring samples of multiple rows. Additionally, the neighboring reference samples of the current block may include a total of nH samples neighboring a right boundary of the current block of a size of nW×nH, a total of nW samples neighboring a bottom boundary of the current block, and one sample neighboring a bottom-right of the current block.

However, some of the neighboring reference samples of the current block may not yet be decoded or may not be available. In this case, the image decoding apparatus 200 may construct the neighboring reference samples for prediction by substituting the unavailable samples with available samples. Alternatively, neighboring reference samples for prediction may be constructed through interpolation of the available samples.

When neighboring reference samples are derived, (i) prediction sample may be derived based on the average or interpolation of the neighboring reference samples of the current block, and (ii) prediction sample may be derived based on reference sample located in a specific (prediction) direction for prediction sample among the neighboring reference samples of the current block. Case (i) may be referred to as a non-directional mode or a non-angular mode, and case (ii) may be referred to as a directional mode or an angular mode. Additionally, the prediction sample may be generated through interpolation between the first neighboring sample and the second neighboring sample located in a direction opposite to the prediction direction of the intra prediction mode of the current block based on the prediction sample of the current block among the neighboring reference samples. The above-described case may be referred to as linear interpolation intra prediction (LIP). Additionally, chroma prediction samples may be generated based on luma samples using a linear model. This case may be called a LM mode. Additionally, a temporary prediction sample of the current block may be derived based on filtered neighboring reference samples, and a prediction sample of the current block may be derived by calculating a weighted sum of at least one of a reference sample derived according to the intra prediction mode among the conventional neighboring reference samples, i.e. unfiltered neighboring reference samples, and the temporary prediction sample. The above-described case is referred to as Position-dependent intra prediction (PDPC). In addition, intra prediction encoding may be performed in a method in which a reference sample line with the highest prediction accuracy among the neighboring multi-reference sample lines of a current block is selected to derive a prediction sample by using a reference sample located in a prediction direction on a corresponding line and a used reference sample line is indicated (signaled) to an image decoding apparatus 200. The above-described case may be called multi-reference line (MRL) intra prediction or MRL-based intra prediction. In addition, a current block is divided into vertical or horizontal sub-partitions to perform intra prediction based on the same intra prediction mode, but neighboring reference samples may be derived and used in the unit of the sub-partition. In other words, in this case, the intra prediction mode for the current block is applied identically to the subpartitions, and the neighboring reference sample are derived and used for each subpartition unit, thereby intra prediction performance may be improved in some cases. This prediction method is referred to as intra sub-partitions (ISP) or ISP-based intra prediction. The above-described intra prediction methods may be called an intra prediction type. The intra prediction type may be called various terms such as an intra prediction technique or an additional intra prediction mode, etc. For example, the intra prediction type (or an additional intra prediction mode, etc.) may include at least one of the above-described LIP, PDPC, MRL, or ISP. A general intra prediction method that excludes specific intra prediction type such as the LIP, the PDPC, the MRL, the ISP, etc. may be referred to as a normal intra prediction type. The normal intra prediction type may be generally applied when the specific intra prediction type described above is not used, and prediction may be performed based on the intra prediction mode described above. Meanwhile, post-processing filtering may be performed on the derived prediction sample when necessary.

Specifically, the intra prediction procedure may include an intra prediction mode/type determination step, a neighboring reference sample derivation step, and an intra prediction mode/type-based prediction sample derivation step. Additionally, a post-filtering step may be performed on the derived prediction sample when necessary.

Meanwhile, in addition to the intra prediction types described above, affine linear weighted intra prediction (ALWIP) may be used. The ALWIP may also be referred to as linear weighted intra prediction (LWIP) or matrix weighted intra prediction or matrix-based intra prediction (MIP). When MIP is applied to a current block, prediction samples for the current block may be derived by i) using neighboring reference samples on which an averaging procedure has been performed, ii) performing a matrix-vector multiplication procedure, and iii) further performing a horizontal/vertical interpolation procedure when necessary. Intra prediction modes used for MIP may be configured differently from those used in LIP, PDPC, MRL, ISP intra prediction, or normal intra prediction described above. The intra prediction mode for MIP may be referred to as the MIP intra prediction mode, MIP prediction mode, or MIP mode. For example, the matrix and offset used in the matrix-vector multiplication may be set differently depending on the intra prediction mode for MIP. Here, the matrix may be referred to as (MIP) weight matrix, and the offset may be referred to as the (MIP) offset vector or (MIP) bias vector.

### EMBODIMENT

The present disclosure relates to a ternary geometric partitioning based predictor generation (TGIP) method. The present disclosure proposes a method for determining a prediction mode to generate a prediction block based on a TGIP mode, a method for deriving prediction information when a TGIP mode is used and methods for generating a prediction block based on derived prediction information.

A TGIP mode proposed in the present disclosure may provide an effect of effectively expressing an object in a scene where a new object is generated on the background, unlike the existing GPM. In addition, a TGIP mode may provide an effect of improving the performance of a prediction block because one additional region (i.e., a total of three regions) is blended to various widths or regions, while the existing GPM blends two predictors (prediction blocks).

The features of a TGIP mode proposed in the present disclosure are as follows.

1. In a TGIP mode, one block may be partitioned into three regions by using one angle to generate one predictor. For example, two straight lines are defined based on one angle, and one block may be partitioned into three regions by using two defined straight lines. “Region” is a result obtained by partitioning a block, which may correspond to “lower block”, “sub-block”, “sub-region”, etc. for a block.

2. When two straight lines are defined by one angle, the total number of regions that may be partitioned by two straight lines may vary depending on an angle.

3. Whether a TGIP mode is allowed in a coded video sequence (CVS) or a coded layer video sequence (CLVS) may be determined through explicit syntax transmission in a HLS (a VPS, a SPS, a PPS, a Picture Header, a Slice Header, DCI, etc.).

4. Whether a TGIP mode is applied at a specific block level (a level defined by a size and/or a shape and/or information of a current block derived based on previously reconstructed information, etc.) may be determined through explicit syntax transmission.

5. In a TGIP mode, information on an angle may be explicitly transmitted through a bitstream or may be implicitly derived from a decoder.

6. In a TGIP mode, information for defining two straight lines may be explicitly transmitted through a bitstream or may be implicitly derived from a decoder.

7. In a TGIP mode, a syntax may be explicitly transmitted through a bitstream or may be implicitly defined in order to adaptively determine a combination of regions supported for each specific block level (a level defined by a size and/or a shape and/or information of a current block derived based on previously reconstructed information, etc.), i.e., the number of partitions.

8. In a TGIP mode, two straight lines may be defined by one angle for each specific block level (a level defined by a size and/or a shape and/or information of a current block derived based on previously reconstructed information, etc.), and the size of three regions partitioned by using two straight lines may be adaptively determined.

9. In a TGIP mode, the prediction mode of the three partitioned regions may be the same or different.

10. In a TGIP mode, motion information or prediction information (an intra prediction mode and/or intra motion information, etc.) of each region may be derived for three partitioned regions.

11. In a TGIP mode, in order to derive motion information or prediction information (an intra prediction mode and/or intra motion information, etc.) of three regions, a syntax may be explicitly transmitted through a bitstream or may be implicitly derived.

12. In a TGIP mode, one motion information list and/or prediction information list may be configured to derive motion information or prediction information of three regions.

13. In a TGIP mode, a motion information list and/or a prediction information list may be configured for each region to derive motion information or prediction information of three regions.

14. In a TGIP mode, a blending process may be performed to combine predictors (prediction regions) derived through three motion information or prediction information into one predictor (the prediction block of a current block). “Prediction region” is a result of predicting a region partitioned from a block, which may be a prediction block for a region.

15. In a TGIP mode, a weight may be defined based on two defined straight lines for a blending process.

16. In a TGIP mode, a blending process may be performed by applying a weight in a blending process.

17. In a TGIP mode, motion information and/or prediction information may be stored in the memory so that derived motion information and/or prediction information may be referenced in the next decoded block.

18. In a TGIP mode, motion information or prediction information may be stored in the unit of a pixel or a unit of a certain size, and in this process, motion information or prediction information may be adaptively stored by considering an angle and two straight lines.

Hereinafter, various embodiments of the present disclosure will be described. Embodiments described below may be performed alone or in combination with at least two.

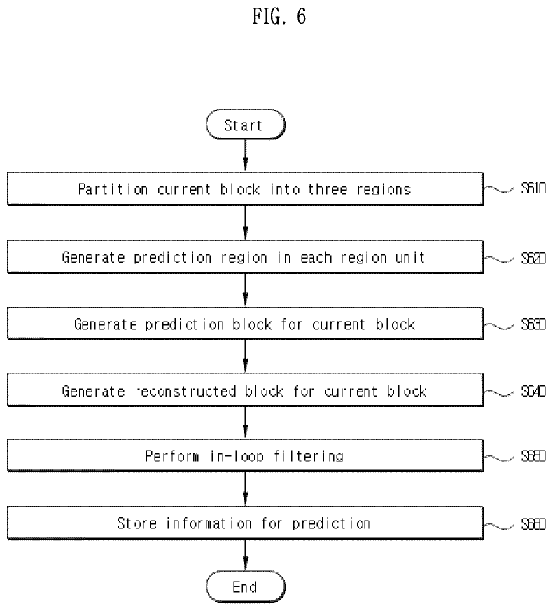

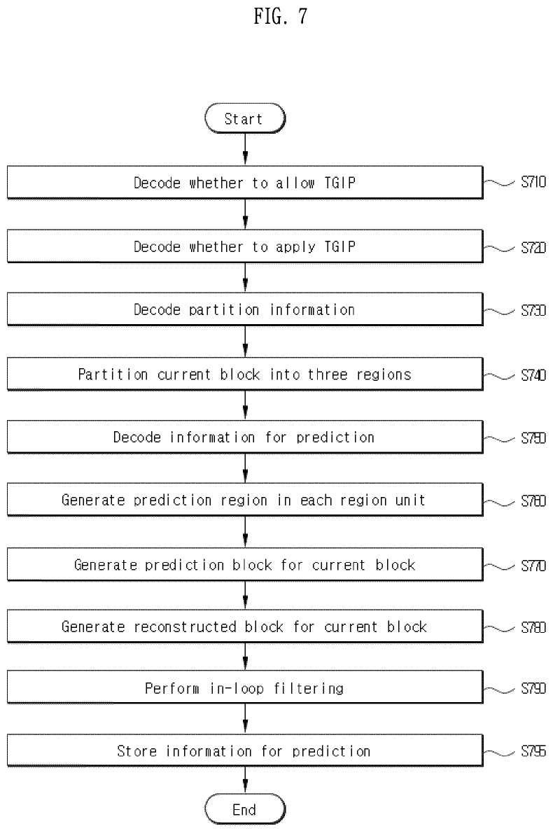

An image encoding method based on a TGIP mode is shown in FIG. 6, and an image decoding method based on a TGIP mode is shown in FIG. 7. The image encoding method of FIG. 6 may be performed by an image encoding apparatus 100, and the image decoding method of FIG. 7 may be performed by an image decoding apparatus 200. Some of the processes in the encoding/decoding process of FIGS. 6 and 7 may be bypassed in some cases, and the order of the processes may be changed as needed.

Referring to FIG. 6, whether to allow a TGIP mode for CVS and/or CLVS may be determined, and whether to apply a TGIP mode at a specific block level when a TGIP mode is allowed may be determined. Whether to allow a TGIP mode may also be determined and transmitted in other units such as a SPS, a PPS, a Picture, a Slice, etc. When a TGIP mode is applied at a specific block level, a current block may be partitioned into three regions based on partition information, i.e., two straight lines expressed by a specific angle S610. Information for prediction (a prediction mode and/or prediction information) may be determined in the unit of each region, and each region may be predicted based on determined information for prediction to generate a total of three prediction regions S620. A final prediction block (a prediction block for a current block) may be generated based on three generated prediction regions S630. A reconstructed block for a current block may be generated by using a generated prediction block and a residual signal (a residual block for a current block) S640, and a reconstructed block may be in-loop filtered by using partition information S650. Information for predicting each region may be stored in memory S660.

Referring to FIG. 7, whether to allow a TGIP mode for CVS and/or CLVS may be decoded and determined S710, and whether to apply a TGIP mode at a specific block level when a TGIP mode is allowed may be decoded and determined S720. When a TGIP mode is applied at a specific block level, partition information, i.e., information on two straight lines expressed by a specific angle, may be decoded or implicitly derived S730, and a current block may be partitioned into three regions based on partition information S740. Information for prediction (a prediction mode and/or prediction information) may be decoded or implicitly derived in the unit of each region S750, and each region may be predicted based on information for prediction to generate a total of three prediction regions S760. A final prediction block (a prediction block for a current block) may be generated based on three generated prediction regions S770. A reconstructed block for a current block may be generated by using a generated prediction block and a residual signal (a residual block for a current block) S780, and a reconstructed block may be in-loop filtered by using partition information S790. Information for predicting each region may be stored in memory S795.

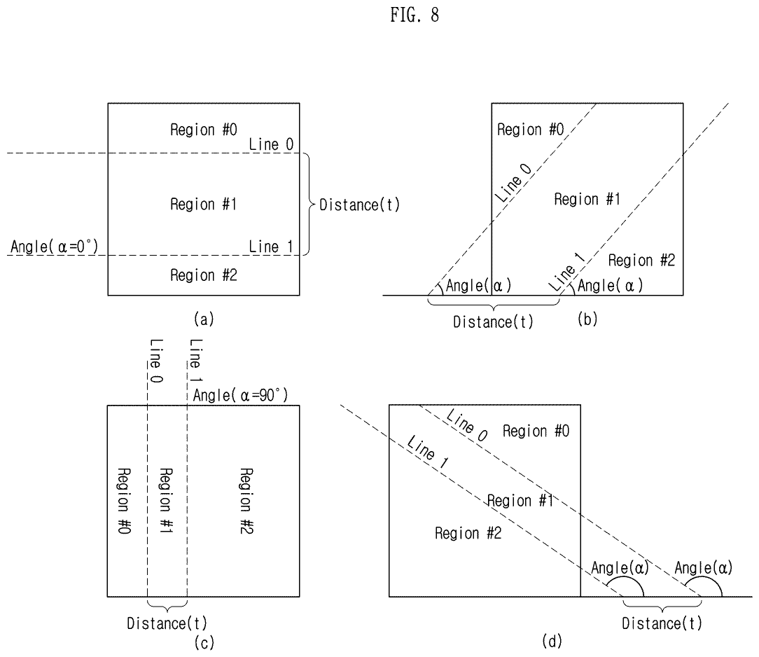

Examples of the process of partitioning a current block into three regions are shown in FIG. 8. Referring to FIG. 8(a), a current block is expressed as a horizontal angle, and may be partitioned into three regions (Region #0, Region #1, Region #2) by two straight lines (Line 0, Line 1) having a predetermined distance. Referring to FIG. 8(b), a current block is expressed as an upward angle, and may be partitioned into three regions (Region #0, Region #1, Region #2) by two straight lines (Line 0, Line 1) having a predetermined distance. Referring to FIG. 8(c), a current block is expressed as a vertical angle, and may be partitioned into three regions (Region #0, Region #1, Region #2) by two straight lines (Line 0, Line 1) having a predetermined distance. Referring to FIG. 8(d), a current block is expressed as a downward angle, and may be partitioned into three regions (Region #0, Region #1, Region #2) by two straight lines (Line 0, Line 1) having a predetermined distance.

For three regions partitioned by two parallel straight lines as in the example of FIG. 8, a prediction mode (an inter mode, an intra mode, an IBC mode, etc.) may be determined to generate prediction regions, and necessary prediction information (motion information, an intra prediction mode, IBC prediction information, etc.) may be decoded and determined according to each determined prediction mode. Prediction regions may be generated based on decoded and determined prediction information.

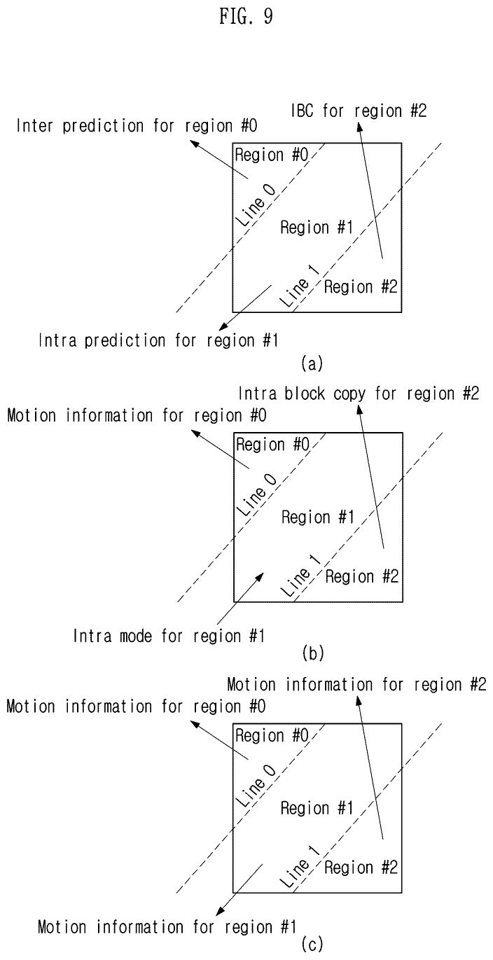

FIG. 9 shows examples of a prediction mode and prediction information determined for each region. As in FIG. 9(a), a prediction region for three regions may be generated by using at least one different prediction mode. According to embodiments, by considering the amount of information transmitted through a bitstream while supporting various prediction modes, the directionality of an intra prediction mode may be constrained, or the motion prediction region of inter prediction may be constrained, or a prediction region may be generated by using only a constrained intra prediction mode.

As in FIG. 9(b), prediction information required to generate a prediction region may be encoded and decoded for each region. Alternatively, the process of encoding and decoding at least one prediction information for prediction information and mapping and storing them in a prediction information storage region corresponding to each region may be additionally performed.

As in FIG. 9(c), when the prediction mode of all regions is determined as an inter prediction mode, prediction information for prediction of all regions may be derived as motion information.

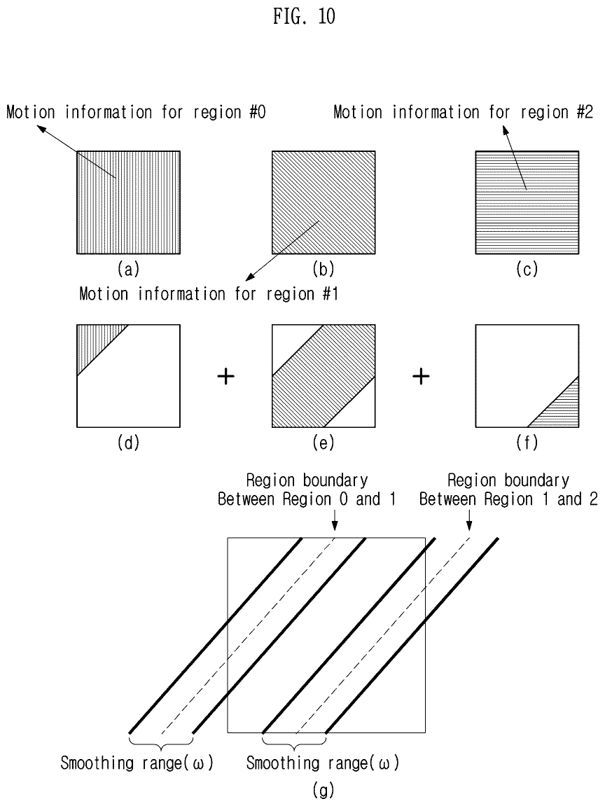

FIG. 10 shows an example in which prediction regions for regions are generated based on information for prediction and a prediction block for a current block is generated based on generated regions.

As in FIG. 10(a) to (c), prediction regions for each region may be generated based on information for prediction of each region. As in FIG. (d) to (f), generated prediction regions may be combined (or summed) to generate a final prediction block (a prediction block for a current block). In the process of summing prediction regions, blending in a smoothing method may be applied to remove discontinuity in pixel values that may occur at the boundary of each prediction region. As in FIG. 10(g), a smoothing range may be defined based on two straight lines (region boundaries) that partition each region. Prediction regions may be summed so that a smoothing effect such as a method for weighted summing the prediction region value of each region is applied. A smoothing range may be a straight line or may have a variable value according to each region.

For a reconstructed block generated based on a prediction block, in-loop filtering may be performed by considering an angle and/or two straight line information and/or a smoothing range, etc. which are the partition information of a TGIP mode in order to improve subjective image quality. Whether to allow in-loop filtering and/or the size of a filtered region and/or filtering strength, etc. may be adaptively defined. Alternatively, when a blending process is already applied to the boundary of a region within a prediction block generated through a TGIP mode, it is determined that the same smoothing process as in-loop filtering is already applied, so an in-loop filtering process may be skipped.

Information for prediction (a prediction mode and/or prediction information) used in a TGIP mode may be stored in memory for reference in a block that is decoded next. Information for prediction may be adaptively stored in memory by considering an angle and/or two straight line information and/or a smoothing range, etc. which are the partition information of a TGIP mode.

### Embodiment 1

In order to determine whether to allow a TGIP mode, a syntax may be explicitly transmitted through a Video Parameter Set (VPS), a Sequence Parameter Set (SPS), a Picture Parameter Set (PPS), a Picture Header (PH) and Decoding capability information (DCI) which are non-VCL NAL and/or a Slice Header (SH) which is VCL NAL.

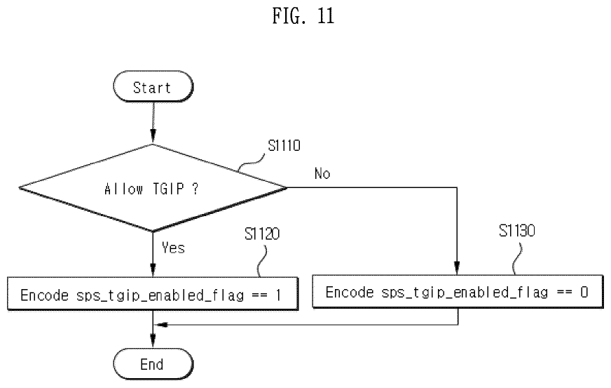

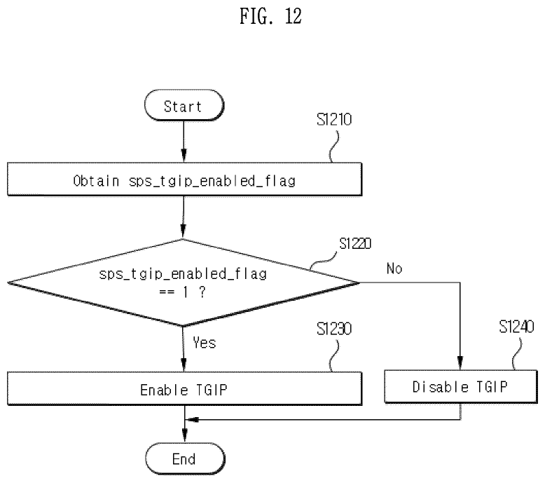

An image encoding method for whether to allow a TGIP mode is shown in FIG. 11, and an image decoding method for whether to allow a TGIP mode is shown in FIG. 12. The image encoding method of FIG. 11 may be performed by an image encoding apparatus 100, and the image decoding method of FIG. 12 may be performed by an image decoding apparatus 200.

Referring to FIG. 11, whether to allow a TGIP mode may be determined S1110, and based on the result of a corresponding determination, allowance information may be encoded S1120 and S1130. The allowance information is information representing whether a TGIP mode is allowed, and may be a syntax such as sps_tgip_enabled_flag. When a TGIP mode is allowed, sps_tgip_enabled_flag may be encoded as a value of 1 S1120, and when a TGIP mode is not allowed, sps_tgip_enabled_flag may be encoded as a value of 0 S1130.

Referring to FIG. 12, when sps_tgip_enabled_flag is obtained from a bitstream S1210, whether to enable a TGIP mode may be determined according to the value of sps_tgip_enabled_flag. When the value of sps_tgip_enabled_flag is 1 S1220, a TGIP mode may be enabled S1230, and when the value of sps_tgip_enabled_flag is 0 S1220, a TGIP mode may be disabled S1240. Specifically, when the value of sps_tgip_enabled_flag is 1, a TGIP mode may be allowed in the unit of a slice referring to a corresponding parameter set or header information or a unit belonging to a specific level less than or equal to it (a coding unit, a prediction unit, etc.) When the value of sps_tgip_enabled_flag is 0, a TGIP mode may not be allowed in the unit of a slice referring to a corresponding parameter set or header information or a unit belonging to a specific level less than or equal to it (a coding unit, a prediction unit, etc.) In this case, when there is a limit that a TGIP mode is not allowed in a high level syntax, a syntax for whether to allow a TGIP mode may be implicitly set as 0 in the unit of a unit belonging to a low level.

An example in which allowance information is signaled through a SPS level is shown in Table 4. A SPS level is just an example, and allowance information may be signaled through a PPS, a PH, a SH, etc.

TABLE 4

| | Descriptor |
|---|---|
| seq_parameter_set_rbsp( ) { | |
| ... | |
| sps_tgip_enabled_flag | u(1) |
| } | |

1, the value of sps_tgip_enabled_flag, may represent that a TGIP mode (or ternary geometric partition based motion compensation) is enabled in CLVS, and merge_tgip_partition_idx, merge_tgip_idx0, and merge_tgip_idx1 and merge_tgip_idx2 may exist in the coding unit syntax of CLVS. 0, the value of sps_tgip_enabled_flag, may represent that a TGIP mode is disabled in CLVS, and merge_tgip_partition_idx, merge_tgip_idx0, and merge_tgip_idx1 and merge_tgip_idx2 may not exist in the coding unit syntax of CLVS. When sps_tgip_enabled_flag does not exist, a value of sps_tgip_enabled_flag may be inferred as 0.

Meanwhile, a syntax for defining the number of prediction candidates required to derive prediction information in a TGIP mode may be signaled. Table 5 shows a syntax for deriving prediction information for three regions by configuring a prediction candidate list with at least two prediction candidates.

TABLE 5

| | Descriptor |
|---|---|
| seq_parameter_set_rbsp( ) { | |
| ... | |
| if( MaxNumMergeCand >= 2 ) { | |
| sps_tgip_enabled_flag | u(1) |
| if( sps_tgip_enabled_flag && MaxNumMergeCand >= 3 ) | |
| sps_max_num_merge_cand_minus_max_num_tgip_cand | ue(v) |
| ... | |
| } | |

sps_max_num_merge_cand_minus_max_num_tgip_cand may represent the maximum number of TGIP merge mode candidates (ternary geometric partitioning merge mode candidates) subtracted from the maximum number of merge candidates (MaxNumMergeCand). The value of sps_max_num_merge_cand_minus_max_num_tgip_cand may have a value from 0 to MaxNumMergeCand−2.

MaxNumTgipMergeCand, the maximum number of TGIP merge mode candidates, may be derived through Equation 1.

$$if ( sps\_tgip \_enabled \_flag \&\& MaxNumMergeCand >= 3 ) \qquad [ Equation 1 ]$$

$$MaxNumTgipMergeCand = MaxNumMergeCand - sps\_max \_num \_merge \_cand \_minus \_max \_num \_tgip \_cand$$

$$else if ( sps\_tgip \_enabled \_flag \&\& MaxNumMergeCand == 2 )$$

$$MaxNumTgipMergeCand = 2$$

$$else$$

$$MaxNumTgipMergeCand = 0$$

Table 6 shows a syntax for allowing three regions to have different prediction information by configuring a prediction candidate list with at least three prediction candidates.

TABLE 6

| | Descriptor |
|---|---|
| seq_parameter_set_rbsp( ) { | |
| ... | |
| if( MaxNumMergeCand >= 3 ) { | |
| sps_tgip_enabled_flag | u(1) |
| if( sps_gpm_enabled_flag && MaxNumMergeCand >= 4 ) | |
| sps_max_num_merge_cand_minus_max_num_tgip_cand | ue(v) |
| ... | |
| } | |

sps_max_num_merge_cand_minus_max_num_tgip_cand may represent the maximum number of TGIP merge mode candidates (ternary geometric partitioning merge mode candidates) subtracted from the maximum number of merge candidates. The value of sps_max_num_merge_cand_minus_max_num_tgip_cand may have a value from 0 to MaxNumMergeCand−3.

MaxNumTgipMergeCand, the maximum number of TGIP merge mode candidates, may be derived through Equation 2.

$$if ( sps\_tgip \_enabled \_flag \&\& MaxNumMergeCand >= 4 ) \qquad [ Equation 2 ]$$

$$MaxNumTgipMergeCand = MaxNumMergeCand - sps\_max \_num \_merge \_cand \_minus \_max \_num \_tgip \_cand$$

$$else if ( sps\_tgip \_enabled \_flag \&\& MaxNumMergeCand == 3 )$$

$$MaxNumTgipMergeCand = 3$$

$$else$$

$$MaxNumTgipMergeCand = 0$$

Meanwhile, a syntax for defining a prediction mode supported in a TGIP mode may be explicitly signaled. Table 7 shows an example of signaling of a syntax for defining a prediction mode.

TABLE 7

| | Descriptor |
|---|---|
| seq_parameter_set_rbsp( ) { | |
| ... | |
| sps_tgip_enabled_flag | u(1) |
| if(sps_tgip_enabled_flag) | |
| sps_tgip_prediction_mode_idc | ue(v) |
| ... | |
| } | |

sps_tgip_prediction_mode_idc may represent the prediction mode of ternary geometric partitioning. The value of sps_tgip_prediction_mode_idc may be defined as in Table 8.

TABLE 8

| sps_tgip_prediction_mode_idc | Definition |
|---|---|
| 0 | Support Inter only |
| 1 | Support Intra only |
| 2 | Support IBC only |
| 3 | Support inter with intra |
| 4 | Support inter with IBC |
| 5 | Support intra with IBC |
| . . . | . . . |

Meanwhile, according to an embodiment of the present disclosure, a case in which a bitstream does not support a TGIP mode by considering decoding capability may be explicitly signaled through constraint information.

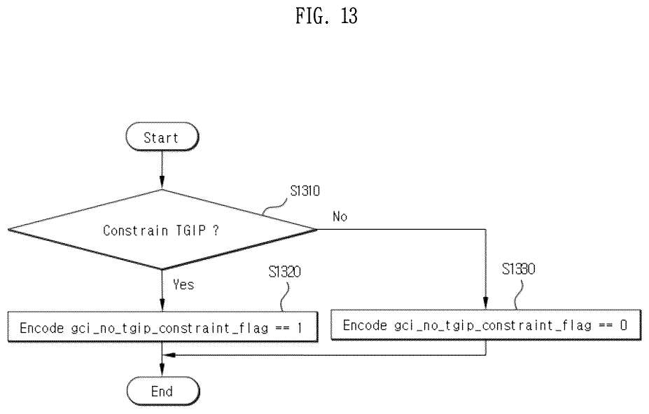

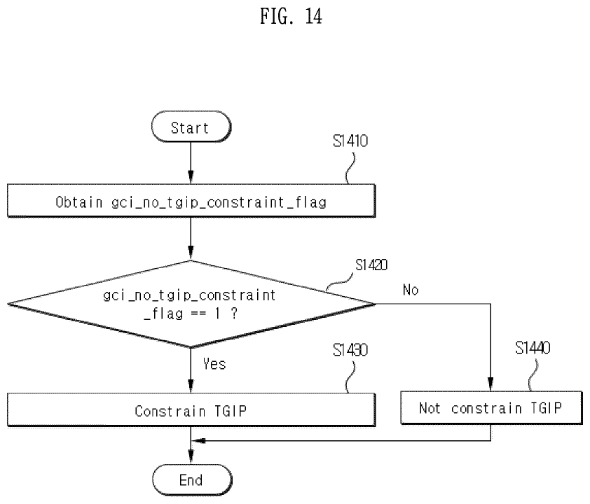

An image encoding method for whether to constrain a TGIP mode is shown in FIG. 13, and an image decoding method for whether to constrain a TGIP mode is shown in FIG. 14. The image encoding method of FIG. 13 may be performed by an image encoding apparatus 100, and the image decoding method of FIG. 14 may be performed by an image decoding apparatus 200.

Referring to FIG. 13, whether to constrain a TGIP mode may be determined S1310. When it is determined to constrain a TGIP mode, constraint information (gci_no_tgip_constraint_flag) may be encoded as a value (e.g., 1) representing that a TGIP mode is constrained S1320, and when it is determined to constrain a TGIP mode, constraint information may be encoded as a value (e.g., 0) representing that a TGIP mode is not constrained S1330.

Referring to FIG. 14, when constraint information is obtained from a bitstream S1410, the value of constraint information may be determined S1420. When the value of constraint information is 1, a TGIP mode is constrained and a TGIP mode may not be allowed to decode a bitstream S1430, and when the value of constraint information is 0, a TGIP mode is not constrained and a TGIP mode may be allowed to decode a bitstream S1440.

An example of constraint information signaled through a DCI NAL unit is shown in Table 9.

TABLE 9

| | Descriptor |
|---|---|
| general_constraints_info( ) { | |
| gci_present_flag | u(1) |
| if( gci_present_flag ) { | |
| ... | |
| gci_no_tgip_constraint_flag | u(1) |
| ... | |
| } | |
| } | |

1, the value of gci_no_tgip_constraint_flag, may represent that the value of sps_tgip_enabled_flag for all pictures in OlsInScope must be 0, and 0, the value of gci_no_tgip_constraint_flag, may represent that a constraint like this is not imposed.

### Embodiment 2

In Embodiment 2, a method is proposed that whether to apply a TGIP mode is explicitly signaled through a specific unit (a coding unit, a prediction unit, etc.) level.

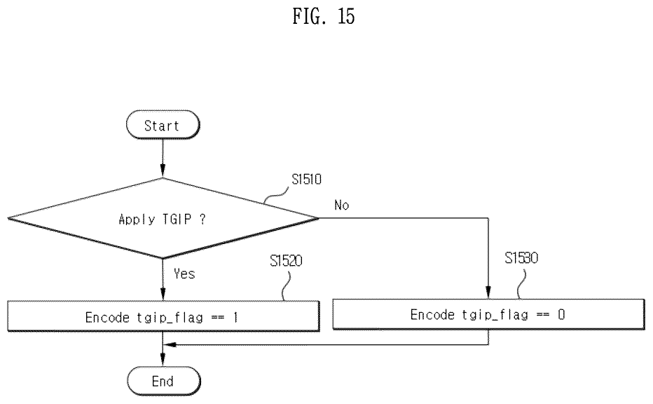

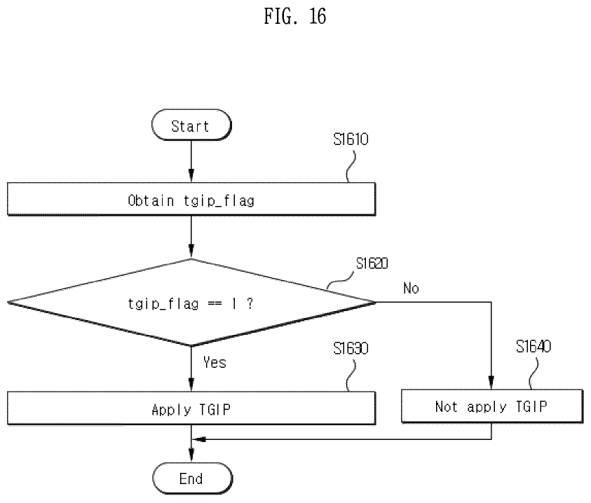

FIG. 15 shows an image encoding method for whether to apply a TGIP mode, and FIG. 16 shows an image decoding method for whether to apply a TGIP mode. The image encoding method of FIG. 15 may be performed by an image encoding apparatus 100, and the image decoding method of FIG. 16 may be performed by an image decoding apparatus 200.

Referring to FIG. 15, whether to apply a TGIP mode to a current block may be determined S1510. When it is determined to apply a TGIP mode, the value of application information (tgip_flag) may be encoded as a value (e.g., 1) representing that a TGIP mode is applied S1520, and when it is determined not to apply a TGIP mode, the value of application information may be encoded as a value (e.g., 0) representing that a TGIP mode is not applied S1530.

Referring to FIG. 16, application information may be obtained from a bitstream S1610, and the value of application information may be determined S1620. When the value of application information is 1, a TGIP mode may be applied S1630, and when the value of application information is 0, a TGIP mode may not be applied S1640.

### Embodiment 3

In Embodiment 3, the partition structure of a TGIP mode is proposed. According to the partition structure of a TGIP mode, a current block may be partitioned into three regions by using two straight lines and one angle. Hereinafter, “partition structure of TGIP mode” will be referred to as “partition structure.”

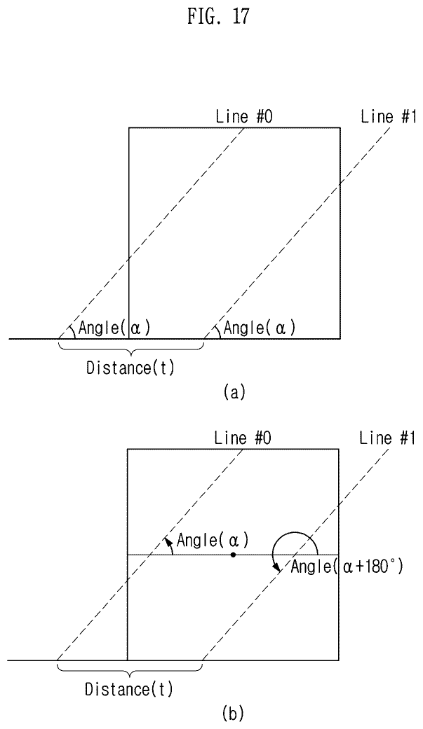

As in FIG. 17(a), an angle (Angle(α)) may have a value greater than or equal to 0 degrees and less than 180 degrees based on a horizontal direction. In addition, as in FIG. 17(b), an angle (Angle(α)) may have a value greater than or equal to 0 degrees and less than 260 degrees based on a horizontal direction. In FIG. 17(b), two straight lines, line #0 and line #1, have the same angle based on a horizontal direction, but may be expressed differently (line #0 is a degrees, line #1 is α+180 degrees) according to a reference position that determines an angle.

The number of combinations that support two straight lines and one angle may be infinite, and among the infinite angles, an angle that may be supported in a TGIP mode may be limited. In addition, in a TGIP mode, a supportable angle may be adaptively defined by considering the size of a block and/or the shape of a block and/or the characteristics of a current block that may be derived through decoded information. In other words, M angles may be supported in a specific block, and N angles may be supported in another specific block.

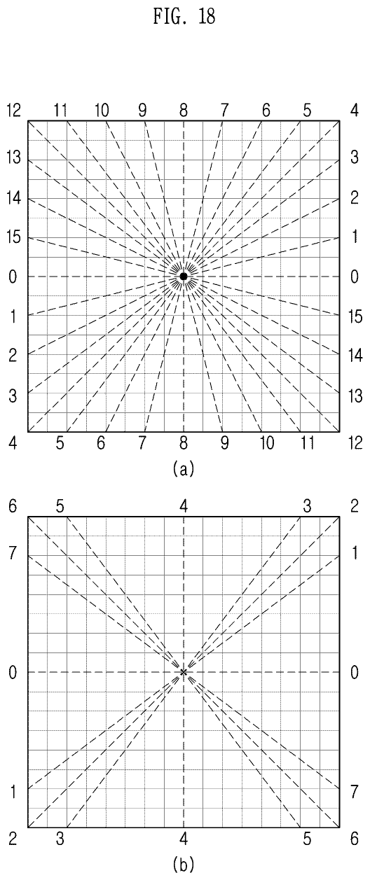

In order to define an angle, angles may be partitioned by a uniform angular difference, as in FIG. 18(a). Alternatively, angles may be partitioned by a nonuniform angular difference, as in FIG. 18(b).

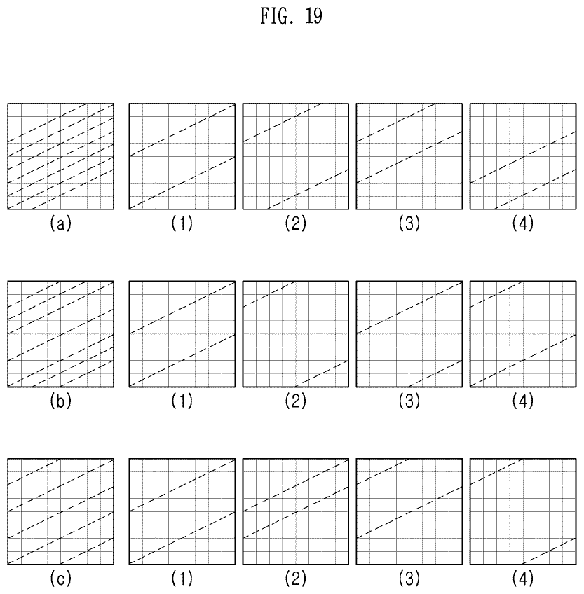

As in examples of FIG. 19, the number of cases in which one block is partitioned into straight lines having a specific angle may be limited. For example, as in FIG. 19 (a), seven straight lines with the same distance between straight lines may be defined so that one block is partitioned into eight arbitrary regions, and a partition structure may be defined through a combination of defined straight lines. In the example, the number of combinations that may be derived from two straight lines among the seven straight lines may be 21. According to embodiments, the partition structure of all combinations may be limited to only specific structures. In other words, among all combinations in FIG. 19(a), it may be limited to four partition structures such as (1) to (4) of FIG. 19(a).

As another example, as in FIG. 19 (b), seven straight lines with a different distance between straight lines may be defined so that one block is partitioned into eight arbitrary regions, and a partition structure may be defined through a combination of defined straight lines. In the example, the number of combinations that may be derived from two straight lines among the seven straight lines may be 21. According to embodiments, the partition structure of all combinations may be limited to only specific structures. In other words, among all combinations in FIG. 19(b), it may be limited to four partition structures such as (1) to (4) of FIG. 19(b).

A distance between straight lines may be adaptively determined, and the number of straight lines may also be adaptively determined. For example, the number of straight lines may be adaptively defined according to the size of a block or decoded information. As in FIG. 19(c), when it is defined that one block is partitioned into six arbitrary regions, the number of straight lines that may be considered is 5, and the number of possible combinations may be limited to 10. In other words, according to the size of a block or decoded information, a different number of partition structures may be supported even at the same angle. Among all combinations in FIG. 19(c), it may be limited to four partition structures such as (1) to (4) of FIG. 19(c).

In this way, in a specific block, specific N combinations among the 21 combinations may be supported, or specific M combinations among the 10 combinations may be supported.

According to embodiments, it may be defined to have a different number of straight lines and a different distance between straight lines for each angle. In addition, according to the width, height or size (the product or sum of the width and the height) of a current block, an angle and a distance supported in a TGIP mode may be limited to a predefined specific type.

It is an example of the description, and a method for defining an angle and/or a method for defining a straight line and/or a combination of partitions that may be derived from a straight line and/or the number of supportable partitions among the partition combinations that may be derived, etc. may be adaptively defined.

### Embodiment 4

In Embodiment 4, when it is determined to generate a prediction block through a TGIP mode at a specific unit (a coding unit, a prediction unit, etc.) level, a method is proposed that explicitly transmits or implicitly derives relevant information (partition information) for partitioning a block (the region of a current block) at the low level of a specific unit in a TGIP mode. In addition, a method for defining a partition mode that may be derived from partition information is also proposed.

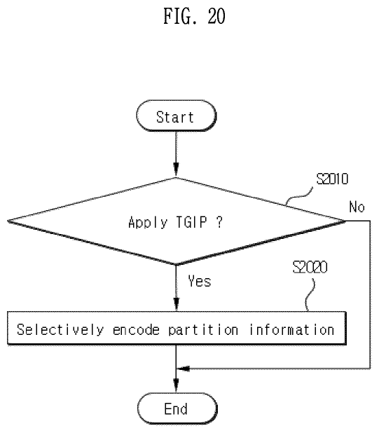

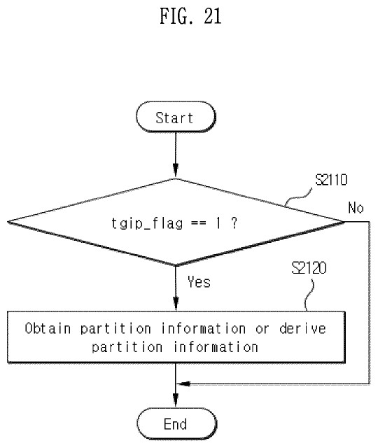

FIG. 20 shows an image encoding method for the derivation of partition information, and FIG. 21 shows an image decoding method for the derivation of partition information. The image encoding method of FIG. 20 may be performed by an image encoding apparatus 100, and the image decoding method of FIG. 21 may be performed by an image decoding apparatus 200.

Referring to FIG. 20, whether a TGIP mode is applied to a current block may be determined S2010. When a TGIP mode is applied, partition information may be selectively encoded S2020. The selective encoding of partition information means that when a TGIP mode is applied, partition information may be encoded and explicitly signaled, or partition information may not be signaled.

Referring to FIG. 21, whether a TGIP mode is applied to a current block based on application information (tgip_flag) may be determined S2110. When a TGIP mode is applied, explicitly signaled partition information may be obtained from a bitstream, or partition information may be derived without signaling partition information S2120.

### Embodiment 4-1

In Embodiment 4-1, a method for explicitly signaling partition information through a bitstream and a method for deriving the partition structure of a TGIP mode based on signaled partition information are proposed. In other words, in Embodiment 4-1, a method for deriving a predefined partition mode by using partition information (ternary_gpm_partition_idx) to derive the partition structure of a current block and a method for signaling partition information (ternary_gpm_partition_idx) are proposed. By methods proposed through Embodiment 4-1, compression efficiency may be refined while minimizing an increase in complexity such as the pipeline delay of a decoder, etc.

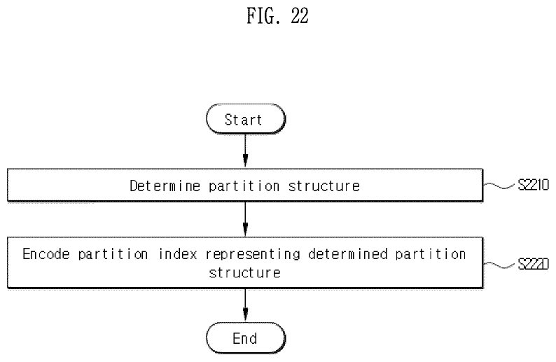

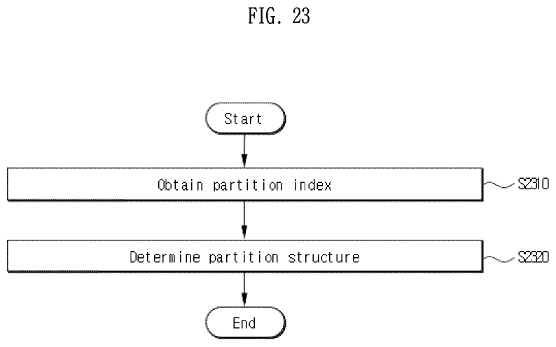

FIG. 22 shows an image encoding method for the derivation of partition information, and FIG. 23 shows an image decoding method for the derivation of partition information. The image encoding method of FIG. 22 may be performed by an image encoding apparatus 100, and the image decoding method of FIG. 23 may be performed by an image decoding apparatus 200.

Referring to FIG. 22, when the partition structure of a current block is determined S2210, partition information representing a determined partition structure may be encoded S2220. Partition information may include a partition index. A partition index may represent any one of the partition structure candidates that may be used to partition a current block.

Referring to FIG. 23, when a partition index is obtained from a bitstream S2310, a partition structure candidate represented by a partition index among the partition structure candidates that may be used to partition a current block may be determined as the partition structure of a current block S2320.

The example of partition structure candidates is shown in Table 10.

TABLE 10

| ternary_gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 15 |
| angleIdx | 0 | 0 | 0 | 0 | 1 | 1 | 1 | 1 | 1 | 2 | 2 | 2 | 2 | 3 | 3 | 3 |
| partitionIdx | 0 | 1 | . . . | A | 0 | 1 | . . . | B | 0 | 1 | . . . | C | 0 | 1 | . . . | D |
| ternary_gpm_ | | | | | | | | | | | | | | | | |
| partition_idx | 16 | 17 | 18 | 19 | 20 | 21 | 22 | 23 | 24 | 25 | 26 | 27 | 28 | 29 | . . . | X-1 |
| angleIdx | 4 | 4 | 4 | 4 | 5 | 5 | 5 | 5 | 6 | 6 | 6 | 6 | 7 | 7 | 7 | Y |
| partitionIdx | 0 | 1 | . . . | E | 0 | 1 | . . . | F | 0 | 1 | . . . | G | 0 | 1 | . . . | H |

In Table 10, ternary_gpm_partition_idx represents a partition index, angleIdx represents an index that may derive angle information (a partition angle index), and partitionIdx represents an index that may derive a partition structure (a partition position index). In other words, each partition structure candidate may include a partition angle index and a partition position index. Based on a partition angle index and a partition position index represented by a partition index, the partition structure of a current block may be determined.

X (X is a natural number greater than or equal to 0) partition structures (partition structure candidates) supported for one block may be defined. The number of angles for deriving a partition structure may be defined, and the number of combinations of straight lines for supporting a partition structure may also be defined.

In addition, X partition structures may represent the sum of the number of angles and the number of combinations between straight lines. X partition structures may be derived through a partition index (ternary_gpm_partition_idx). In other words, a combination of angles and straight lines may be derived by using a signaled partition index. The number of partitions defined for each angle (A, B, C, D, E, F, G, H, . . . ) may have the same value or may have a different value. When the number of partitions defined for each angle has the same value, the same number of partitions may be supported for each angle. When the number of partitions defined for each angle has a different value, a different number of partitions may be supported for each angle.

The example of partition structure candidates where X, the total number of partition structures, is defined as 32 and 4 partitions are defined for each angle is shown in Table 11.

TABLE 11

| ternary_gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 15 |
| angleIdx | 0 | 0 | 0 | 0 | 1 | 1 | 1 | 1 | 2 | 2 | 2 | 2 | 3 | 3 | 3 | 3 |
| partitionIdx | 0 | 1 | 2 | 3 | 0 | 1 | 2 | 3 | 0 | 1 | 2 | 3 | 0 | 1 | 2 | 3 |
| ternary_gpm_ | | | | | | | | | | | | | | | | |
| partition_idx | 16 | 17 | 18 | 19 | 20 | 21 | 22 | 23 | 24 | 25 | 26 | 27 | 28 | 29 | 30 | 31 |
| angleIdx | 4 | 4 | 4 | 4 | 5 | 5 | 5 | 5 | 6 | 6 | 6 | 6 | 7 | 7 | 7 | 7 |
| partitionIdx | 0 | 1 | 2 | 3 | 0 | 1 | 2 | 3 | 0 | 1 | 2 | 3 | 0 | 1 | 2 | 3 |

A partition structure may support only some angles, such as an angle as in FIG. 18(b) among the supportable angles as in FIG. 18(a). However, FIG. 18 is an example, and an angle supported by a partition structure may be angles different from those in FIG. 18(b), and angleIdx representing this may have a different value according to the number of supported angles.

When angleIdx 1 is selected among the partition structure candidates in Table 11, the number of cases in which two straight lines are generated at an angle defined by angleIdx 1 to partition one block may be infinite. However, for convenience of a description, it is described based on four partition structures such as (1) to (4) of FIG. 19(a) among the 21 combinations as in FIG. 19(a).

Partition structures such as (1) to (4) of FIG. 19(a) may be defined as 4 to 7, the value of a partition index, among the partition structure candidates in Table 11. In other words, when the value of a partition index signaled through a bitstream is 5, a current block may be partitioned into a partition structure in (2) of FIG. 19(a).

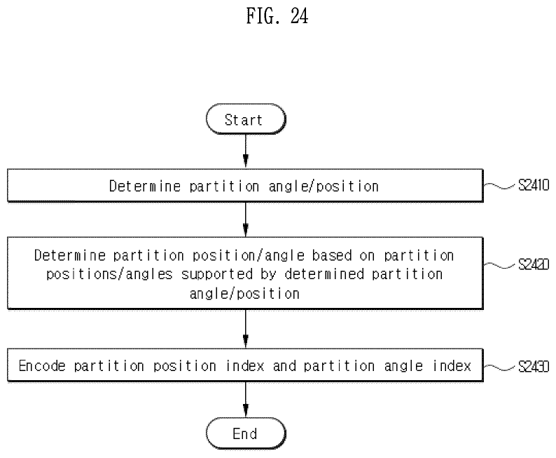

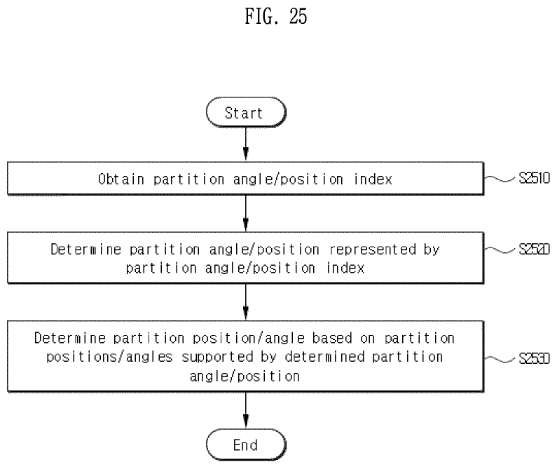

Meanwhile, a partition angle index and a partition position index for deriving a partition structure may also be signaled. FIG. 24 shows an image encoding method for signaling a partition angle index and a partition position index, and FIG. 25 shows an image decoding method for signaling a partition angle index and a partition position index. The image encoding method of FIG. 24 may be performed by an image encoding apparatus 100, and the image decoding method of FIG. 25 may be performed by an image decoding apparatus 200.

Referring to FIG. 24, when a partition structure/position is determined S2410, a partition position/angle may be determined based on partition positions/angles supported by a determined partition structure/position S2420. Specifically, when a partition angle is determined, any one of the partition positions supported by a determined partition angle may be determined as the partition position of a current block. In addition, when a partition position is determined, any one of the partition angles supported by a determined partition position may be determined as the partition angle of a current block.

A partition angle index representing a determined partition angle and a partition position index representing a determined partition position may be encoded S2430. For example, a partition angle index may be signaled first, and then a partition position index may be adaptively signaled according to the number of partitions (the number of partition positions) supported by a signaled partition angle index. As another example, a partition position index may be signaled, and a partition angle index may be adaptively signaled according to the number of angles (the number of partition angles) supported by a signaled partition position index.

Referring to FIG. 25, when a partition angle/position index is obtained from a bitstream S2510, a partition angle/position represented by a partition angle/position index may be determined S2520. In addition, any one of the partition positions/angles supported by a determined partition angle/position may be determined S2530. Specifically, when a partition angle is determined, any one of the partition positions supported by a determined partition angle may be determined as the partition position of a current block. In addition, when a partition position is determined, any one of the partition angles supported by a determined partition position may be determined as the partition angle of a current block.

### Embodiment 4-2

In Embodiment 4-2, a method for more efficiently signaling partition information is proposed.

The template matching cost of partition structures (or, partition structure candidates) is calculated, and after reordering partition structures in ascending order based on a calculated cost, a partition structure index value may be defined in reordered order. In other words, among the partition structures, a partition structure with a high probability of selection may have a priority. In this way, when a partition structure with a high probability of selection has a high priority, a small amount of bits are signaled through a bitstream to derive or determine a partition structure with a high probability of selection, so compression efficiency may be refined.

When there are 32 partition structure candidates as in the example of Table 12, it may be the same as in Table 13 when a template matching cost for 32 partition structure candidates is calculated and partition structure candidates are reordered in ascending order based on a calculated template matching cost.

TABLE 12

| ternary_gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 15 |
| angleIdx | 0 | 0 | 0 | 0 | 1 | 1 | 1 | 1 | 2 | 2 | 2 | 2 | 3 | 3 | 3 | 3 |
| partitionIdx | 0 | 1 | 2 | 3 | 0 | 1 | 2 | 3 | 0 | 1 | 2 | 3 | 0 | 1 | 2 | 3 |
| ternary_gpm_ | | | | | | | | | | | | | | | | |
| partition_idx | 16 | 17 | 18 | 19 | 20 | 21 | 22 | 23 | 24 | 25 | 26 | 27 | 28 | 29 | 30 | 31 |
| angleIdx | 4 | 4 | 4 | 1 | 5 | 5 | 5 | 5 | 6 | 6 | 6 | 6 | 7 | 7 | 7 | 7 |
| partitionIdx | 0 | 1 | 2 | 3 | 0 | 1 | 2 | 3 | 0 | 1 | 2 | 3 | 0 | 1 | 2 | 3 |

TABLE 13

| ternary_gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 15 |
| angleIdx | 0 | 1 | 2 | 3 | 4 | 5 | 6 | 7 | 0 | 1 | 2 | 3 | 4 | 5 | 6 | 7 |
| partitionIdx | 0 | 0 | 0 | 0 | 0 | 0 | 0 | 0 | 1 | 1 | 1 | 1 | 1 | 1 | 1 | 1 |
| ternary_gpm_ | | | | | | | | | | | | | | | | |
| partition_idx | 16 | 17 | 18 | 19 | 20 | 21 | 22 | 23 | 24 | 25 | 26 | 27 | 28 | 29 | 30 | 31 |
| angleIdx | 0 | 1 | 2 | 3 | 4 | 5 | 6 | 7 | 0 | 1 | 2 | 3 | 4 | 5 | 6 | 7 |
| partitionIdx | 2 | 2 | 2 | 2 | 2 | 2 | 2 | 2 | 3 | 3 | 3 | 3 | 3 | 3 | 3 | 3 |

When ordering is not performed as in Table 12, ternary_gpm_partition_idx with a value of 8 must be signaled to derive a partition structure defined as 2, the value of angleIdx, and 0, the value of partitionIdx. However, when ordering is performed as in Table 13, ternary_gpm_partition_idx with a value of 2 must be signaled to derive a partition structure defined as 2, the value of angleIdx, and 0, the value of partitionIdx.

Since an ordering process must also be performed in a decoder, a complexity problem may occur. In order to solve this, the following methods may be used.

For example, angleIdx may be fixed, the template matching cost of a partition structure corresponding to partitionIdx supported by fixed angleIdx may be calculated, and partition positions may be reordered in ascending order based on a template matching cost. In other words, partition positions for a corresponding angle may define partitionIdx in order of priority, and corresponding partitionIdx may be signaled.

As another example, partitionIdx may be fixed, the template matching cost of a partition structure for an angle supporting fixed partitionIdx may be calculated, and angles may be reordered in ascending order based on a template matching cost. In other words, angleIdx may be defined in order of priority for an angle supporting a corresponding partition position, and corresponding angleIdx may be signaled.

According to embodiments, the gradient of the neighboring reconstructed reference samples of a current block is calculated to derive an angle value, and an amplitude corresponding to a calculated gradient may be calculated and accumulated in the unit of a gradient. In this case, each gradient may be defined as one angle value. A current block may be partitioned by using an angle defined as a gradient with the largest amplitude value or a gradient with the smallest amplitude value based on the amplitude of an accumulated gradient.

According to embodiments, the gradient of the neighboring reconstructed reference samples of a current block is calculated to derive an angle value, and an amplitude corresponding to a calculated gradient may be calculated and accumulated in the unit of a gradient. In this case, each gradient may be defined as one angle value. A current block may be partitioned by using an angle that is perpendicular to an angle defined as a gradient with the largest amplitude value or a gradient with the smallest amplitude value based on the amplitude of an accumulated gradient.

### Embodiment 5

In Embodiment 5, a method is proposed that derives prediction information for generating prediction regions for three regions.

The prediction region of each region may be generated based on at least one of an intra mode (or, an intra prediction mode), an inter mode (or, an inter prediction mode) and an IBC mode (or, an IBC prediction mode). In other words, all prediction modes for three regions may be the same or different. Alternatively, prediction modes for two regions among the three regions may be the same, and a prediction mode for the remaining one region may be different.

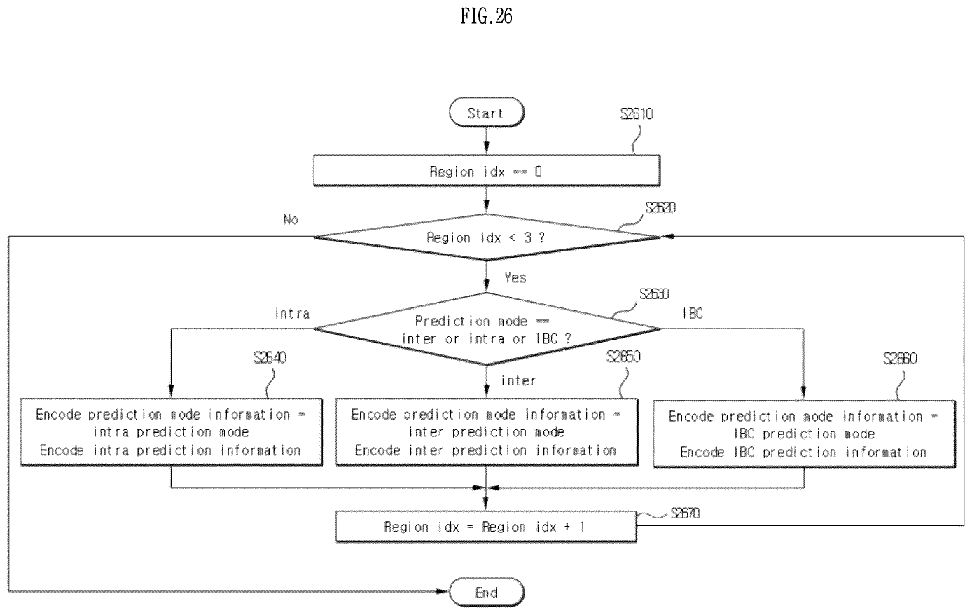

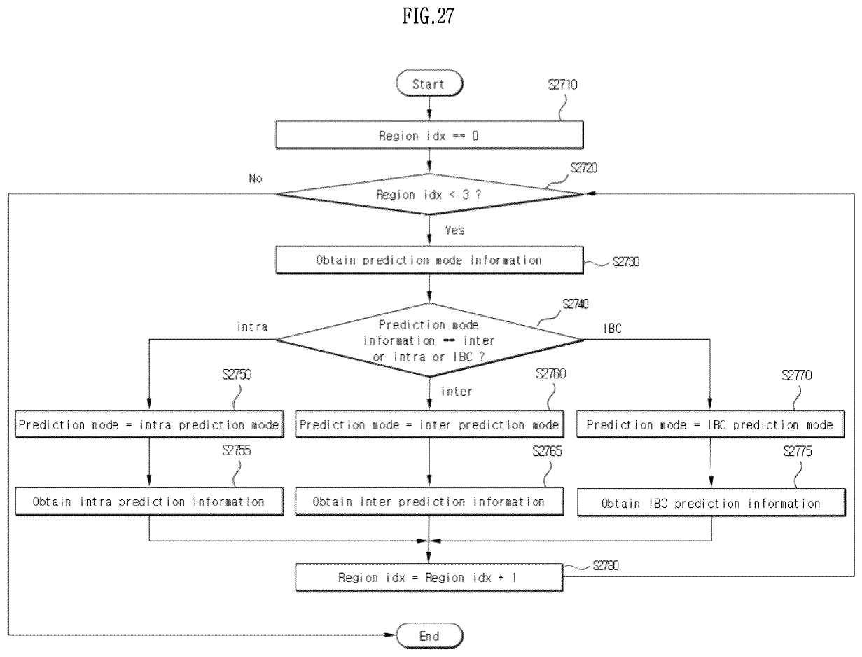

FIG. 26 shows an example of an image encoding method for deriving a prediction mode, and FIG. 27 shows an example of an image decoding method for deriving a prediction mode. The image encoding method of FIG. 26 may be performed by an image encoding apparatus 100, and the image decoding method of FIG. 27 may be performed by an image decoding apparatus 200.

Referring to FIG. 26, a region index (Region idx) for identifying regions may be set as an initial value (e.g., 0) S2610, and whether a prediction mode is determined for all regions may be determined S2620. When there is a region where a prediction mode is not determined, a prediction mode for a corresponding region may be determined S2630. When a prediction mode for a corresponding region is an intra mode (intra), prediction mode information may be encoded as an intra mode, and intra prediction information (e.g., intra prediction mode) for performing intra prediction may be encoded S2640. When a prediction mode for a corresponding region is an inter mode (inter), prediction mode information may be encoded as an inter mode, and inter prediction information (e.g., motion information) for performing inter prediction may be encoded S2650. When a prediction mode for a corresponding region is an IBC mode, prediction mode information may be encoded as an IBC mode, and IBC prediction information (e.g., block vector) for performing IBC prediction may be encoded S2660. After increasing the value of a region index by 1 S2670, whether a prediction mode is determined for all regions may be determined again S2620. These processes may be performed repeatedly to determine and encode a prediction mode for all regions.

Referring to FIG. 27, a region index (Region idx) for identifying regions may be set as an initial value (e.g., 0) S2710, and whether a prediction mode is derived for all regions may be determined S2720. When there is a region where a prediction mode is not derived, prediction mode information for a corresponding region may be obtained from a bitstream S2730, and a prediction mode for a corresponding region may be determined based on obtained prediction mode information S2740. When a prediction mode for a corresponding region is an intra mode (intra), a prediction mode may be set as an intra mode S2750, and intra prediction information (e.g., an intra prediction mode) for performing intra prediction may be obtained S2755. When a prediction mode for a corresponding region is an inter mode (inter), a prediction mode may be set as an inter mode S2760, and inter prediction information (e.g., motion information) for performing inter prediction may be obtained S2765. When a prediction mode for a corresponding region is an IBC mode, a prediction mode may be set as an IBC mode S2770, and IBC prediction information (e.g., a block vector) for performing IBC prediction may be obtained S2775. After increasing the value of a region index by 1 S2780, whether a prediction mode is derived for all regions may be determined again S2720. These processes may be performed repeatedly to derive a prediction mode for all regions.

Meanwhile, the prediction region of each region may be generated based on only any one of an intra mode, an inter mode and an IBC mode. In other words, a prediction region for three regions may be generated by using only a single prediction mode.

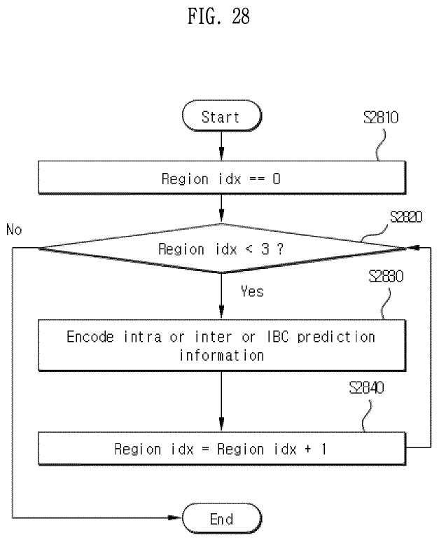

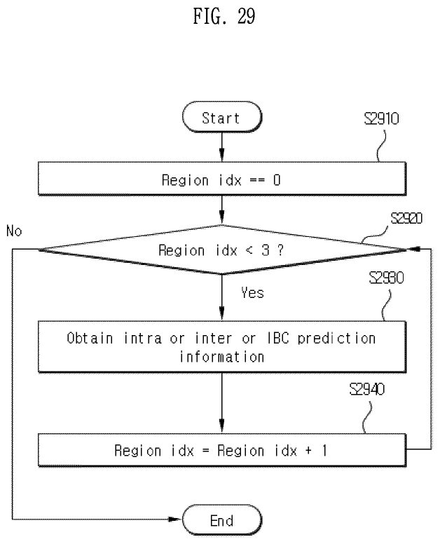

FIG. 28 shows an example of an image encoding method for a single prediction mode, and FIG. 29 shows an example of an image decoding method for a single prediction mode. The image encoding method of FIG. 28 may be performed by an image encoding apparatus 100, and the image decoding method of FIG. 29 may be performed by an image decoding apparatus 200.

Referring to FIG. 28, a region index (Region idx) for identifying regions may be set as an initial value (e.g., 0) S2810, and whether a prediction mode is determined for all regions may be determined S2820. When there is a region where a prediction mode is not determined, a prediction mode for a corresponding region may be encoded as any one of an intra mode, an inter mode and an IBC mode S2830. After increasing the value of a region index by 1 S2840, whether a prediction mode is determined for all regions may be determined again S2820. These processes may be performed repeatedly to determine and encode a single prediction mode for all regions.

Referring to FIG. 29, a region index (Region idx) for identifying regions may be set as an initial value (e.g., 0) S2910, and whether a prediction mode is derived for all regions may be determined S2920. When there is a region where a prediction mode is not derived, prediction mode information for a corresponding region may be obtained from a bitstream S2930, and a prediction mode for a corresponding region may be determined as any one of an intra mode, an inter mode and an IBC mode based on obtained prediction mode information. After increasing the value of a region index by 1 S2400, whether a prediction mode is derived for all regions may be determined again S2920. These processes may be performed repeatedly to derive a single prediction mode for all regions.

Meanwhile, the prediction region of each region may be generated based on only any two of an intra mode, an inter mode and an IBC mode. For example, a prediction region may be generated based on an intra mode and an inter mode, or a prediction region may be generated based on an intra mode and an IBC mode, or a prediction region may be generated based on an inter mode and an IBC mode.

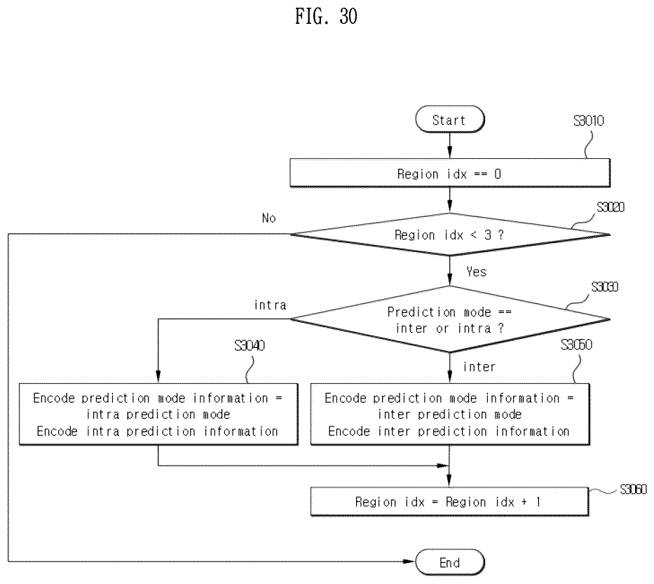

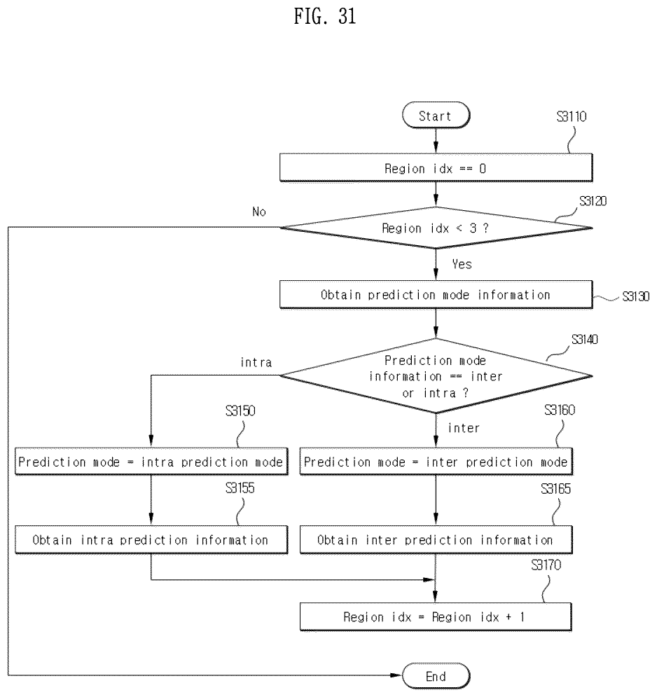

FIG. 30 shows an example of an image encoding method for a two prediction modes, and FIG. 31 shows an example of an image decoding method for two prediction modes. The image encoding method of FIG. 30 may be performed by an image encoding apparatus 100, and the image decoding method of FIG. 31 may be performed by an image decoding apparatus 200.

Referring to FIG. 30, a region index (Region idx) for identifying regions may be set as an initial value (e.g., 0) S3010, and whether a prediction mode is determined for all regions may be determined S3020. When there is a region where a prediction mode is not determined, a prediction mode for a corresponding region may be determined S3030. When a prediction mode for a corresponding region is an intra mode (intra), prediction mode information may be encoded in an intra mode, and intra prediction information (e.g., an intra prediction mode) for performing intra prediction may be encoded S3040. When a prediction mode for a corresponding region is an inter mode (inter), prediction mode information may be encoded in an inter mode, and inter prediction information (e.g., motion information) for performing inter prediction may be encoded S3050. After increasing the value of a region index by 1 S3060, whether a prediction mode is determined for all regions may be determined again S3020. These processes may be performed repeatedly to determine and encode a prediction mode for all regions.

Referring to FIG. 31, a region index (Region idx) for identifying regions may be set as an initial value (e.g., 0) S3110, and whether a prediction mode is derived for all regions may be determined S3120. When there is a region where a prediction mode is not derived, prediction mode information for a corresponding region may be obtained from a bitstream S3130, and a prediction mode for a corresponding region may be determined based on obtained prediction mode information S3140. When a prediction mode for a corresponding region is an intra mode (intra), a prediction mode may be set as an intra mode S3150, and intra prediction information (e.g., an intra prediction mode) for performing intra prediction may be obtained S3155. When a prediction mode for a corresponding region is an inter mode (inter), a prediction mode may be set as an inter mode S3160, and inter prediction information (e.g., motion information) for performing inter prediction may be obtained S3165. After increasing the value of a region index by 1 S3170, whether a prediction mode is derived for all regions may be determined again S3120. These processes may be performed repeatedly to derive a prediction mode for all regions.

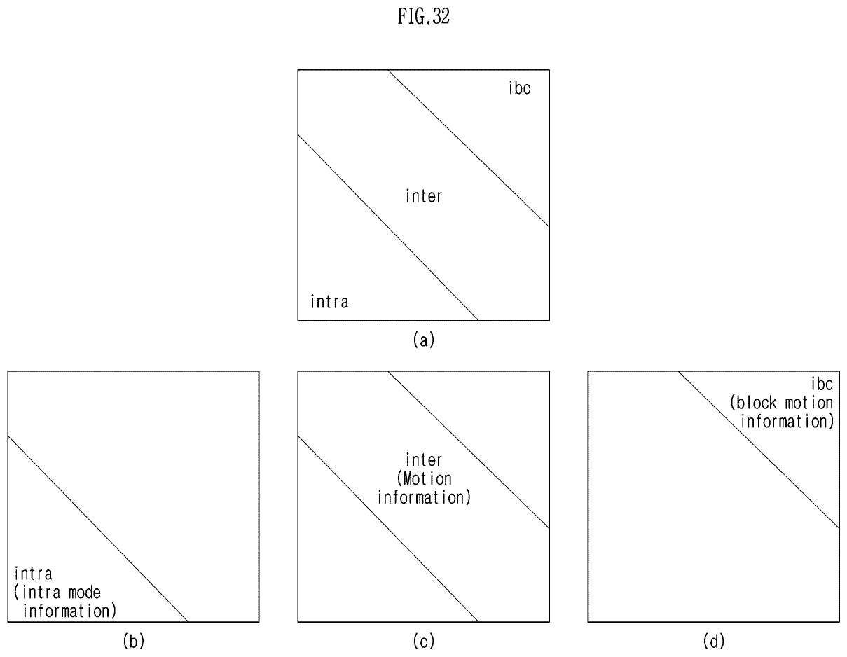

According to embodiments, prediction information (an intra prediction mode, motion information, a block vector, etc.) which is information required to generate a prediction region may be explicitly signaled or implicitly derived in the unit of a region. As in FIG. 32(a), a current block may be partitioned into three regions, and prediction regions for partitioned regions may be generated by using a different prediction mode. In this case, prediction information required to generate the prediction region of each region may be signaled or derived.

### Embodiment 6

In Embodiment 6, various examples of partition structure candidates are proposed.

As shown in Table 14, whether a GPM is ternary partitioned may be defined by adding merge_gpm_partition_idx (a partition index) to the existing GPM.

TABLE 14

| merge_ gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 35 |
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| ternarySplit | 0 | 0 | 0 | 0 | 0 | 0 | 0 | 0 | 0 | 0 | 0 | 0 | 0 | 0 | 0 | 0 |
| merge_ gpm_ | | | | | | | | | | | | | | | | |
| partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 3 | 2 | 3 | 0 | 1 | 2 | 3 |
| ternarySplit | 0 | 0 | 0 | 0 | 0 | 0 | 0 | 0 | 0 | 0 | 0 | 0 | 0 | 0 | 0 | 0 |
| merge_ gpm_ | | | | | | | | | | | | | | | | |
| partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| ternarySplit | 0 | 0 | 0 | 0 | 0 | 0 | 0 | 0 | 0 | 0 | 0 | 0 | 0 | 0 | 0 | 0 |
| merge_ gpm_ | | | | | | | | | | | | | | | | |
| partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |
| ternarySplit | 0 | 0 | 0 | 0 | 0 | 0 | 0 | 0 | 0 | 0 | 0 | 0 | 0 | 0 | 0 | 0 |
| merge_ gpm_ | | | | | | | | | | | | | | | | |
| partition_idx | 64 | 65 | 66 | 67 | 68 | 69 | 70 | 71 | 72 | 73 | 74 | 75 | 76 | 77 | 78 | 79 |
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| ternarySplit | 1 | 1 | 1 | 1 | 1 | 1 | 1 | 1 | 1 | 1 | 1 | 1 | 1 | 1 | 1 | 1 |
| merge_ gpm_ | | | | | | | | | | | | | | | | |
| partition_idx | 80 | 81 | 82 | 83 | 84 | 85 | 86 | 87 | 88 | 89 | 90 | 91 | 92 | 93 | 94 | 95 |
| angleIdx | 5 | 5 | 8 | 8 | 11 | 11 | 11 | 11 | 12 | 12 | 12 | 12 | 13 | 13 | 13 | 13 |
| distancekIdx | 2 | 3 | 1 | 3 | 0 | 1 | 2 | 3 | 0 | 1 | 2 | 3 | 0 | 1 | 2 | 3 |
| ternary Split | 1 | 1 | 1 | 1 | 1 | 1 | 1 | 1 | 1 | 1 | 1 | 1 | 1 | 1 | 1 | 1 |
| merge_ gpm_ | | | | | | | | | | | | | | | | |
| partition_idx | 96 | 97 | 98 | 99 | 100 | 101 | 102 | 103 | 104 | 105 | 106 | 107 | 108 | 109 | 110 | 111 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| ternarySplit | 1 | 1 | 1 | 1 | 1 | 1 | 1 | 1 | 1 | 1 | 1 | 1 | 1 | 1 | 1 | 1 |
| merge_ gpm_ | | | | | | | | | | | | | | | | |
| partition_idx | 112 | 113 | 114 | 115 | 116 | 117 | 118 | 119 | 120 | 121 | 122 | 123 | 124 | 125 | 126 | 127 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |
| ternarySplit | 1 | 1 | 1 | 1 | 1 | 1 | 1 | 1 | 1 | 1 | 1 | 1 | 1 | 1 | 1 | 1 |

Each merge_gpm_partition_idx (i.e., each partition structure candidate indicated by merge_gpm_partition_idx) may include angleIdx that may derive an angle (a partition angle index), distanceIdx that may derive a partition (distance index) and ternarySplit that represents whether it is ternary partitioned (ternary information).

merge_gpm_partition_idx that the value of ternarySplit is defined as 0 may represent that ternary partition is not applied and a current block is binary partitioned into two regions in the same way as the existing GPM. merge_gpm_partition_idx that the value of ternarySplit is defined as 1 may represent that a current block is ternary partitioned into three regions.

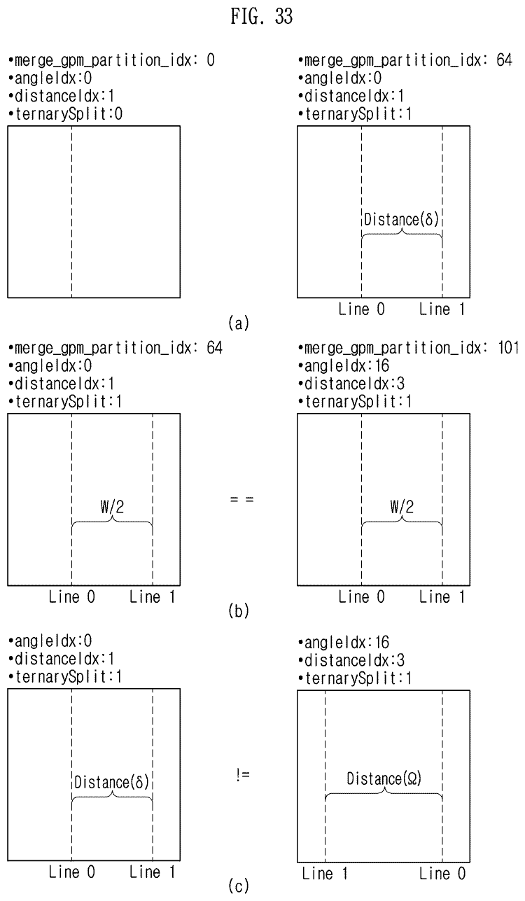

For example, when the value of merge_gpm_partition_idx is 0, the value of ternarySplit is 0, so a current block may be partitioned into a structure where angleIdx is 0 and distanceIdx is 1, as in FIG. 33(a). As another example, when the value of merge_gpm_partition_idx is 64, the value of ternarySplit is 1, so a current block may be ternary partitioned.

0, the value of angleIdx, means that partition is performed at the same angle as angleIdx 0 in the existing GPM. However, 1, the value of distanceIdx, defines 2 straight linesm while partition is performed by using a straight line at a position defined by distanceIdx 1 in the existing GPM. Based on one straight line defined at the position of distanceIdx, the remaining one straight line may be defined at a predefined distance, as in FIG. 33(a). In other words, in order to derive two straight lines, line 0 may be defined at the position of distanceIdx 1, and line 1 may be defined at a position that is spaced apart by a distance (Distance(δ)) between predefined straight lines. In other words, a distance Distance(δ) between line 0 and line 1 may be predefined. Distance(δ) may have an integer value, and may have the same value for all angles or a different value for each angle. In addition, Distance(δ) may have the same value or a different value according to the size of a block. The value of Distance(δ) may be predefined in a decoder, or may be defined in Non-VCL NA such as SPS/PPS/PH/APS/DCI and VCL NAL such as SH. In addition, the value of Distance(δ) may be predefined as a value of Width/N or Height/N according to an angle, and N may be an arbitrary integer.

When Distance(δ) is predefined as a value of Width/2, as in FIG. 33(b), a partition structure when merge_gpm_partition_idx is 64 and a partition structure when merge_gpm_partition_idx is 101 are the same, so the same prediction regions may be generated. In order to solve this redundancy, as in FIG. 33(c), the value of a distance for defining line 1 according to angleIdx may be defined to have a different value adaptively such as Distance(δ) and Distance(Q).

According to another embodiment, as shown in Table 15, among the ternary partition structures that may be generated by two straight lines, some partition structures may be predefined and new distanceIdx may be allocated to them. In other words, unlike a method described above, which defines one straight line based on distanceIdx and another straight line spaced apart at the position of Distance(δ) from it, new distanceIdx, 4, 5, 6, 7, . . . , M may be defined for a partition structure predefined for each angle, and a partition structure corresponding to the distanceIdx of each angle may be defined.

TABLE 15

| merge_ gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 15 |
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_ gpm_ | | | | | | | | | | | | | | | | |
| partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 2 | 3 | 0 | 1 | 2 | 3 | 0 | 1 | 2 | 3 |
| merge_ gpm_ | | | | | | | | | | | | | | | | |
| partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 19 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_ gpm_ | | | | | | | | | | | | | | | | |
| partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |
| merge_ gpm_ | | | | | | | | | | | | | | | | |
| partition_idx | 64 | 65 | 66 | 67 | 68 | 69 | 70 | 71 | 72 | 73 | 74 | 75 | 76 | 77 | 78 | 79 |
| angleIdx | 0 | 0 | 2 | 2 | 2 | 2 | 3 | 3 | 3 | 3 | 4 | 4 | 4 | 4 | 5 | 5 |
| distanceIdx | 4 | 5 | 4 | 5 | 6 | 7 | 4 | 5 | 6 | 7 | 4 | 5 | 6 | 7 | 4 | 5 |
| merge_ gpm_ | | | | | | | | | | | | | | | | |
| partition_idx | 80 | 81 | 82 | 83 | 84 | 85 | 86 | 87 | 88 | 89 | 90 | 91 | 92 | 93 | 94 | 95 |
| angleIdx | 5 | 5 | 8 | 8 | 11 | 11 | 11 | 11 | 12 | 12 | 12 | 12 | 13 | 13 | 13 | 13 |
| distanceIdx | 6 | 7 | 4 | 5 | 4 | 5 | 6 | 7 | 4 | 5 | 6 | 7 | 4 | 5 | 6 | 7 |
| merge_ gpm_ | | | | | | | | | | | | | | | | |
| partition_idx | 96 | 97 | 98 | 99 | 100 | 101 | 102 | 103 | 104 | 105 | 106 | 107 | 108 | 109 | 110 | 111 |
| angleIdx | 14 | 14 | 14 | 14 | 16 | 16 | 18 | 18 | 18 | 19 | 19 | 19 | 20 | 20 | 20 | 23 |
| distanceIdx | 4 | 5 | 6 | 7 | 4 | 5 | 4 | 5 | 6 | 4 | 5 | 6 | 4 | 4 | 5 | 3 |
| merge_ gpm_ | | | | | | | | | | | | | | | | |
| partition_idx | 112 | 113 | 114 | 115 | 116 | 117 | 118 | 119 | 120 | 121 | 122 | 123 | 124 | 125 | 126 | 127 |
| angleIdx | 21 | 21 | 24 | 24 | 27 | 27 | 27 | 28 | 28 | 28 | 29 | 29 | 29 | 30 | 30 | 30 |
| distanceIdx | 4 | 5 | 4 | 5 | 3 | 4 | 5 | 4 | 5 | 4 | 5 | 4 | 5 | 4 | 5 | 6 |

In Table 15, partition structure candidates where the value of distanceIdx is 0 to 3 may be binary partition structure candidates, and partition structure candidates where the value of distanceIdx is 4 to M(6) may be ternary partition structure candidates. In other words, the embodiment of Table 15 may be an embodiment for distinguishing binary partition and ternary partition according to the value of distanceIdx.

According to another embodiment, binary partition and ternary partition may be distinguished based on the value of angleIdx. In other words, for ternary partition, considering that a prediction effect thereof may be different according to an angle, the number of partitions supported for each angle may be adaptively determined. Alternatively, ternary partition may not be supported for a specific angle.

Table 16 is an example of partition structure candidates for distinguishing binary partition and ternary partition according to the value of angleIdx.

TABLE 16

| merge_ gpm_ | | | | | | | | | | | | | | | | |
|---|---|---|---|---|---|---|---|---|---|---|---|---|---|---|---|---|
| partition_idx | 0 | 1 | 2 | 3 | 4 | 5 | 6 | 7 | 8 | 9 | 10 | 11 | 12 | 13 | 14 | 15 |
| angleIdx | 0 | 0 | 2 | 2 | 2 | 2 | 3 | 3 | 3 | 3 | 4 | 4 | 4 | 4 | 5 | 5 |
| distanceIdx | 1 | 3 | 0 | 1 | 2 | 3 | 0 | 1 | 2 | 3 | 0 | 1 | 2 | 3 | 0 | 1 |
| merge_ gpm_ | | | | | | | | | | | | | | | | |
| partition_idx | 16 | 17 | 18 | 19 | 20 | 21 | 22 | 23 | 24 | 25 | 26 | 27 | 28 | 29 | 30 | 31 |
| angleIdx | 5 | 5 | 8 | 8 | 11 | 11 | 11 | 11 | 12 | 12 | 12 | 12 | 13 | 13 | 13 | 13 |
| distanceIdx | 2 | 3 | 1 | 3 | 0 | 1 | 3 | 3 | 0 | 1 | 2 | 3 | 0 | 1 | 2 | 3 |
| merge_ gpm_ | | | | | | | | | | | | | | | | |
| partition_idx | 32 | 33 | 34 | 35 | 36 | 37 | 38 | 39 | 40 | 41 | 42 | 43 | 44 | 45 | 46 | 47 |
| angleIdx | 14 | 14 | 14 | 14 | 16 | 16 | 18 | 18 | 18 | 19 | 19 | 19 | 20 | 20 | 20 | 21 |
| distanceIdx | 0 | 1 | 2 | 3 | 1 | 3 | 1 | 2 | 3 | 1 | 2 | 3 | 1 | 2 | 3 | 1 |
| merge_ gpm_ | | | | | | | | | | | | | | | | |
| partition_idx | 48 | 49 | 50 | 51 | 52 | 53 | 54 | 55 | 56 | 57 | 58 | 59 | 60 | 61 | 62 | 63 |
| angleIdx | 21 | 21 | 24 | 24 | 27 | 27 | 27 | 28 | 28 | 28 | 29 | 29 | 29 | 30 | 30 | 30 |
| distanceIdx | 2 | 3 | 1 | 3 | 1 | 2 | 3 | 1 | 2 | 3 | 1 | 2 | 3 | 1 | 2 | 3 |
| merge_ gpm_ | | | | | | | | | | | | | | | | |
| partition_idx | 64 | 65 | 66 | 67 | 68 | 69 | 70 | 71 | 72 | 73 | 74 | 75 | 76 | 77 | 78 | 79 |
| angleIdx | 0 | 0 | 0 | 0 | 4 | 4 | 4 | 4 | 8 | 8 | 8 | 8 | 12 | 12 | 12 | 12 |
| distanceIdx | 4 | 5 | 6 | 7 | 4 | 5 | 6 | 7 | 4 | 5 | 6 | 7 | 4 | 5 | 6 | 7 |

In Table 16, partition structure candidates where the value of angleIdx is 0, 4, 8 and 12 may be ternary partition structure candidates, and partition structure candidates where the value of angleIdx is not 0, 4, 8 and 12 may be binary partition structure candidates. In other words, in the example of Table 16, the number of added X partition structures is 16, and 0, 4, 8 and 12 may be defined so that 4 angles are supported to support 16 partition structures.

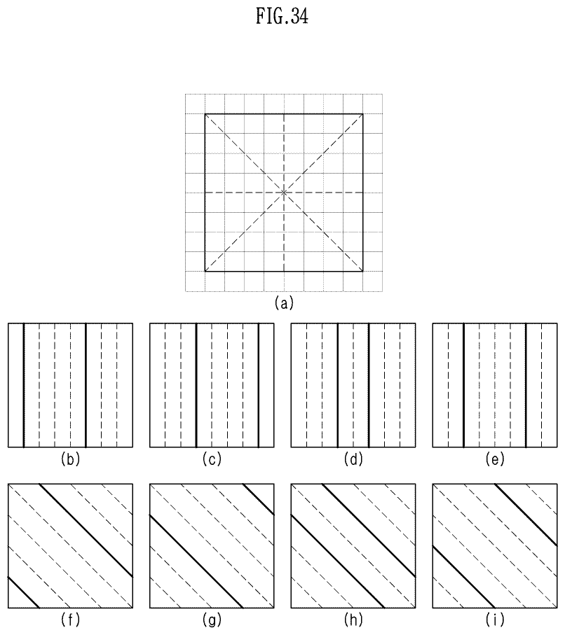

In angles as in FIG. 34(a), distanceIdx may be defined so that 4 predefined ternary partition structures are supported for each angle. For example, when the value of angleIdx is 0 and the value of distanceIdx are 4, 5, 6 and 7, partition structures in FIG. 34(b) to (e) may be defined and mapped. As the same example, when the value of angleIdx is 4 and the value of distanceIdx are 4, 5, 6 and 7, partition structures in FIG. 34(f) to (i) may be defined and mapped.

The methods described in Embodiment 6 are just an example, and X which is the total number of added partition structures, the number of ternary partition structures defined for each angle, etc. may be changed.

### Embodiment 7

In Embodiment 7, a method is proposed that derives prediction information for deriving three prediction regions.

Various prediction modes may be supported for generating the prediction region of a TGIP mode. For example, when (prediction mode of region-0, prediction mode of region-1, prediction mode of region-2) are defined as (X, Y, Z), X, Y, Z may be an inter mode and/or an intra mode and/or an IBC mode.

Table 17 shows a syntax structure that gives support to generate prediction regions by using at least one different prediction mode.

TABLE 17

| | |
|---|---|
| tgip_flag[ x0 ][ y0 ] | ae(v) |
| if(tgip_flag){ | |
| tgip_partition_idx[ x0 ][ y0 ] | ae(v) |
| tgip_pred_mode_idx0[ x0 ][ y0 ] | ae(v) |
| if(tgip_pred_mode_idx0[ x0 ][ y0 ] = = INTER){ //inter | |
| tgip_inter_cand_idx0[ x0 ][ y0 ] | ae(v) |
| } | |
| else if (tgip_pred_mode_idx0[ x0 ][ y0 ] = = IBC){ //ibc | |
| tgip_ibc_cand_idx0[ x0 ][ y0 ] | ae(v) |
| } | |
| else { //intra | |
| tgip_intra_cand_idx0[ x0 ][ y0 ] | ae(v) |
| } | |
| tgip_pred_mode_idx1[ x0 ][ y0 ] | ae(v) |
| if(tgip_pred_mode_idx1[ x0 ][ y0 ] = = INTER){ //inter | |
| tgip_inter_cand_idx1[ x0 ][ y0 ] | |
| } | |
| else if (tgip_pred_mode_idx1[ x0 ][ y0 ] = = IBC){ //ibc | |
| tgip_ibc_cand_idx1[ x0 ][ y0 ] | ae(v) |
| } | |
| else {//intra | |
| tgip_intra_cand_idx1[ x0 ][ y0 ] | ae(v) |
| } | |
| tgip_pred_mode_idx2[ x0 ][ y0 ] | ae(v) |
| if(tgip_pred_mode_idx2[ x0 ][ y0 ] = = INTER){ //inter | |
| tgip_inter_cand_idx2[ x0 ][ y0 ] | ae(v) |
| } | |
| else if (tgip_pred_mode_idx2[ x0 ][ y0 ] = = IBC){ //ibc | |
| tgip_ibc_cand_idx2[ x0 ][ y0 ] | ae(v) |
| } | |
| else {//intra | |
| tgip_intra_cand_idx2[ x0 ][ y0 ] | ae(v) |
| } | |

In Table 17, array indexes x0 and y0 may represent the position (x0, y0) of the top-left luma sample of a coding block considered based on the top-left luma sample of a picture.

tgip_flag may represent whether a TGIP mode is applied to a current coding unit. When tgip_flag does not exist, a value of tgip_flag may be inferred as 0.

tgip_partition_idx may represent the partition shape (partition structure) of a TGIP mode. In other words, tgip_partition_idx may be a partition index. When tgip_partition_idx does not exist, a value of tgip_partition_idx may be inferred as 0.

tgip_pred_mode_idx0 may represent the prediction mode of the first geometric partition region (the first region). In other words, tgip_pred_mode_idx0 may be prediction mode information. When tgip_pred_mode_idx0 does not exist, a value of tgip_pred_mode_idx0 may be inferred as inter.

tgip_inter_cand_idx0 may represent the first inter candidate index of a geometric partition (TGIP)-based motion compensation candidate list. tgip_inter_cand_idx0 may be prediction information. When tgip_inter_cand_idx0 does not exist, a value of tgip_inter_cand_idx0 may be inferred as 0.

tgip_intra_cand_idx0 may represent the first intra candidate index of a geometric partition-based intra mode list. tgip_intra_cand_idx0 may be prediction information. When tgip_intra_cand_idx0 does not exist, a value of tgip_intra_cand_idx0 may be inferred as 0.

tgip_ibc_cand_idx0 may represent the first IBC candidate index of a geometric partition-based IBC motion compensation candidate list. tgip_ibc_cand_idx0 may be prediction information. When tgip_ibc_cand_idx0 does not exist, a value of tgip_ibc_cand_idx0 may be inferred as 0.

tgip_pred_mode_idx1 may represent the prediction mode of the second geometric partition region (the second region). In other words, tgip_pred_mode_idx1 may be prediction mode information. When tgip_pred_mode_idx1 does not exist, a value of tgip_pred_mode_idx1 may be inferred as inter.

tgip_inter_cand_idx1 may represent the second inter candidate index of a geometric partition (TGIP)-based motion compensation candidate list. tgip_inter_cand_idx1 may be prediction information. When tgip_inter_cand_idx1 does not exist, a value of tgip_inter_cand_idx1 may be inferred as 0.

tgip_intra_cand_idx1 may represent the second intra candidate index of a geometric partition-based intra mode list. tgip_intra_cand_idx1 may be prediction information. When tgip_intra_cand_idx1 does not exist, a value of tgip_intra_cand_idx1 may be inferred as 0.

tgip_ibc_cand_idx1 may represent the second IBC candidate index of a geometric partition-based IBC motion compensation candidate list. tgip_ibc_cand_idx1 may be prediction information. When tgip_ibc_cand_idx1 does not exist, a value of tgip_ibc_cand_idx1 may be inferred as 0.

tgip_pred_mode_idx2 may represent the prediction mode of the third geometric partition region (the third region). In other words, tgip_pred_mode_idx2 may be prediction mode information. When tgip_pred_mode_idx2 does not exist, a value of tgip_pred_mode_idx2 may be inferred as inter.

tgip_inter_cand_idx2 may represent the third inter candidate index of a geometric partition (TGIP)-based motion compensation candidate list. tgip_inter_cand_idx2 may be prediction information. When tgip_inter_cand_idx2 does not exist, a value of tgip_inter_cand_idx2 may be inferred as 0.

tgip_intra_cand_idx2 may represent the third intra candidate index of a geometric partition-based intra mode list. tgip_intra_cand_idx2 may be prediction information. When tgip_intra_cand_idx2 does not exist, a value of tgip_intra_cand_idx2 may be inferred as 0.

tgip_ibc_cand_idx2 may represent the third IBC candidate index of a geometric partition-based IBC motion compensation candidate list. tgip_ibc_cand_idx2 may be prediction information. When tgip_ibc_cand_idx2 does not exist, a value of tgip_ibc_cand_idx2 may be inferred as 0.

Table 18 shows a relationship between prediction mode information and prediction modes.

TABLE 18

| tgip_pred_mode_idxL | |
|---|---|
| 0 | INTER |
| 1 | IBC |
| 2 | INTRA |

Table 19 shows a syntax structure supporting an intra mode and an inter mode.

TABLE 19

| | |
|---|---|
| tgip_flag[ x0 ][ y0 ] | ae(v) |
| if(tgip_flag){ | |
| tgip_partition_idx[ x0 ][ y0 ] | ae(v) |
| tgip_pred_mode_idx0[ x0 ][ y0 ] | ae(v) |
| if(tgip_pred_mode_idx0[ x0 ][ y0 ] = = 0){ //inter | |
| tgip_inter_cand_idx0[ x0 ][ y0 ] | ae(v) |
| } | |
| else { | |
| tgip_intra_cand_idx0[ x0 ][ y0 ] | ae(v) |
| } | |
| tgip_pred_mode_idx1[ x0 ][ y0 ] | ae(v) |
| if(tgip_pred_mode_idx1[ x0 ][ y0 ] = = 0){ //inter | |
| tgip_inter_cand_idx1[ x0 ][ y0 ] | |
| } | |
| else {//intra | |
| tgip_intra_cand_idx1[ x0 ][ y0 ] | ae(v) |
| } | |
| tgip_pred_mode_idx2[ x0 ][ y0 ] | ae(v) |
| if(tgip_pred_mode_idx2[ x0 ][ y0 ] = = 0){ //inter | |
| tgip_inter_cand_idx2[ x0 ][ y0 ] | ae(v) |
| } | |
| else {//intra | |
| tgip_intra_cand_idx2[ x0 ][ y0 ] | ae(v) |
| } | |
| } | |

Table 20 shows a syntax structure supporting an IBC mode and an inter mode.

TABLE 20

| | |
|---|---|
| tgip_flag[ x0 ][ y0 ] | ae(v) |
| if(tgip_flag) { | |
| tgip_partition_idx[ x0 ][ y0 ] | ae(v) |
| tgip_pred_mode_idx0[ x0 ][ y0 ] | ae(v) |
| if(tgip_pred_mode_idx0[ x0 ][ y0 ] = = 0){ //inter | |
| tgip_inter_cand_idx0[ x0 ][ y0 ] | ae(v) |
| } | |
| else {//IBC | |
| tgip_ibc_cand_idx0[ x0 ][ y0 ] | ae(v) |
| } | |
| tgip_pred_mode_idx1[ x0 ][ y0 ] | ae(v) |
| if(tgip_pred_mode_idx1][ x0 ][ y0 ] = = 0){ //inter | |
| tgip_inter_cand_idx1[ x0 ][ y0 ] | |
| } | |
| else {//IBC | |
| tgip_ibc_cand_idx1[ x0 ][ y0 ] | ae(v) |
| } | |
| tgip_pred_mode_idx2[ x0 ][ y0 ] | ae(v) |
| if(tgip_pred_mode_idx2[ x0 ][ y0 ] = = 0){ //inter | |
| tgip_inter_cand_idx2[ x0 ][ y0 ] | ae(v) |
| } | |
| else {//IBC | |
| tgip_ibc_cand_idx2[ x0 ][ y0 ] | ae(v) |
| } | |
| } | |

Table 21 shows a syntax structure supporting generating a prediction block in the same prediction mode.

TABLE 21

| | |
|---|---|
| tgip_flag[ x0 ][ y0 ] | ae(v) |
| if(tgip_flag){ | |
| tgip_partition_idx[ x0 ][ y0 ] | ae(v) |
| tgip_inter_cand_idx0[ x0 ][ y0 ] | ae(v) |
| tgip_inter_cand_idx1[ x0 ][ y0 ] | ae(v) |
| if( MaxNumTgipCand > 3 ) | |
| tgip_inter_cand_idx2[ x0 ][ y0 ] | ae(v) |
| } | |

According to Table 21, the prediction information (tgip_inter_cand_idx2) of the third region may be signaled only when at least 4 prediction candidates in a prediction candidate list are derived (MaxNumTgipCand>3). When less than 4 prediction candidates in a prediction candidate list are derived, the prediction information of the third region may be derived as the remaining prediction information that is not selected in the first region and the second region. In addition, the prediction information of the third region may be implicitly derived as the prediction information of the first region or the prediction information of the second region, or may be derived as predefined default prediction information.

Only partition information is signaled for a TGIP mode, and for information for prediction for each region (prediction mode information and prediction information), a syntax structure for a method for using a predefined value is shown in Table 22. For example, prediction regions for three regions may be generated by using a predefined prediction mode, and prediction information may be derived from a decoder, or predefined prediction information may be used.

TABLE 22

| | |
|---|---|
| tgip_flag[ x0 ][ y0 ] | ae(v) |
| if(tgip_flag){ | |
| tgip_partition_idx[ x0 ][ y0 ] | ae(v) |

### Embodiment 8

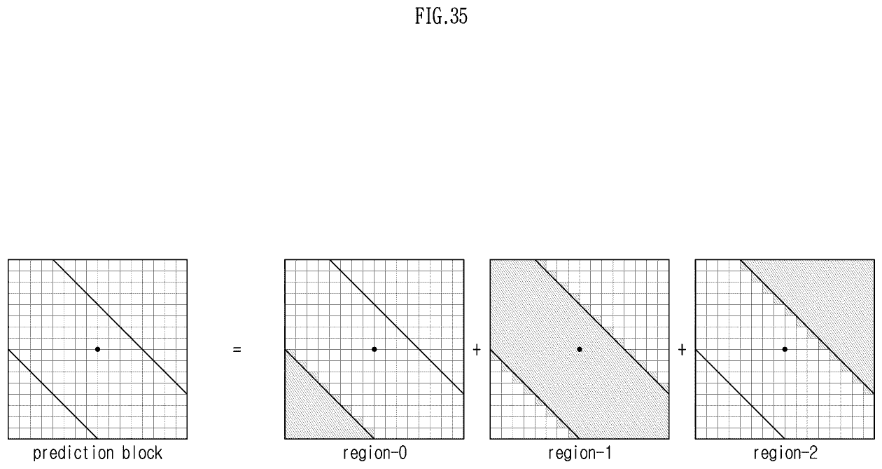

In Embodiment 8, a method for blending each region unit is proposed to generate one final prediction block (the prediction block of a current block) by combining prediction regions generated by a TGIP mode. Embodiment 8 is described based on a prediction block, region-0, region-1 and region-2 illustrated in FIG. 35. Region-0 represents the first prediction region, region-1 represents the second prediction region, and region-2 represents the third prediction region.

### Embodiment 8-1

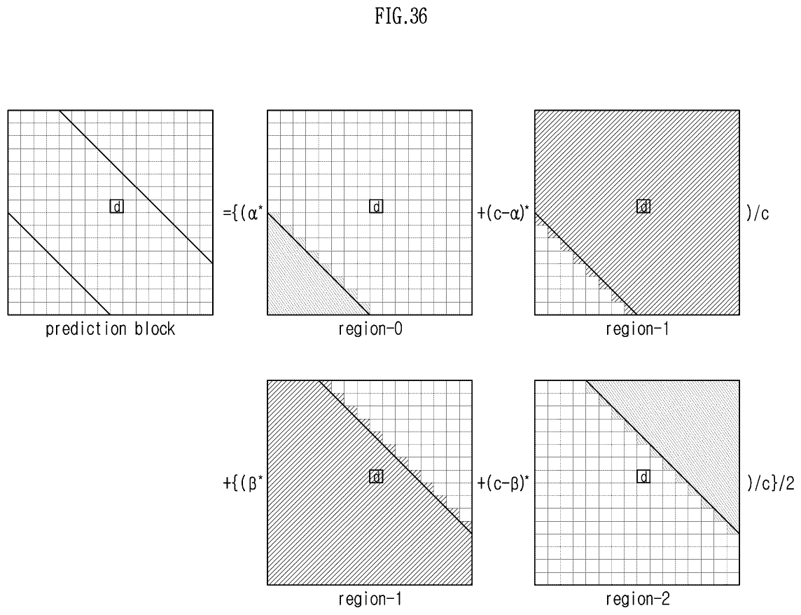

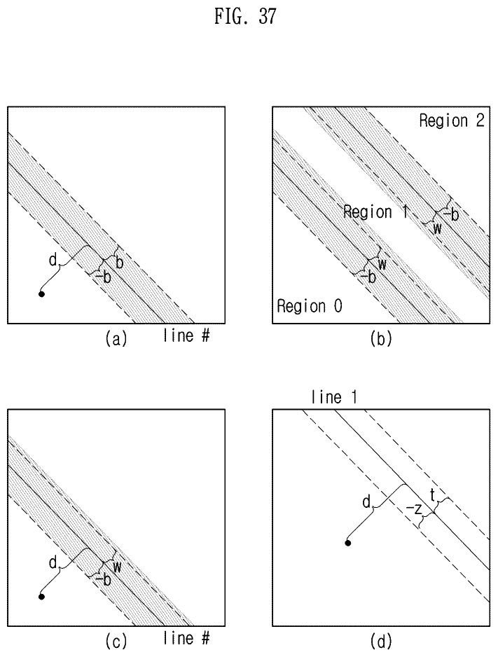

As shown in FIG. 36, a prediction block may be generated by weighted summing a result of blending region-0 and region-1 based on line 0 and a result of blending region-1 and region-2 based on line 2. u and R are a weight value, which may be derived based on a straight line as in FIG. 37. For example, a may be derived based on the first straight line, and β may be derived based on the second straight line. C may represent the maximum value of a weight. α, β and C may have an integer value.

In the example of FIG. 37(a), a weight (α, β) may be derived through Equation 3.

$${b}_{( x , y )} = \{ \begin{matrix}0 , & d \leq - b \\ C / 2 b ( d + b ) , & - b < d < b \\ C , & d \geq b\end{matrix} \qquad [ Equation 3 ]$$

b(x, y) may represent a weight value.

A blending process may be performed asymmetrically based on two straight lines. As in the example of FIG. 37(b), Region 1, which is a region between two straight lines, has a region that is blended on both sides unlike Region 0 and Region 2, so a blending method different from Region 0 and Region 2 needs to be applied.

To this end, a weight derivation method such as FIG. 37(c) may be applied to the bottom-left of Region 1, and a weight derivation method such as FIG. 37(d) may be applied to the top-right of Region 1.

In the example of FIG. 37(c), a weight (α, β) may be derived through Equation 4.

$${α}_{( x , y )} = \{ \begin{matrix}0 , & d \leq - b \\ C / 2 b ( d + b ) , & - b < d < line \\ C / 2 w ( d + w ) , & line \leq d < w \\ C , & d \geq w\end{matrix} \qquad [ Equation 4 ]$$

$$line = b + b / ( b + w )$$

In the example of FIG. 37(d), a weight (α, β) may be derived through Equation 5.

$${γ}_{( x , y )} = \{ \begin{matrix}0 , & d \leq - z \\ C / 2 z ( d + z ) , & - z < d < line \\ C / 2 t ( d + t ) , & line \leq d < t \\ C , & d \geq t\end{matrix} \qquad [ Equation 5 ]$$

$$line = b + t / ( z + t )$$

### Embodiment 8-2

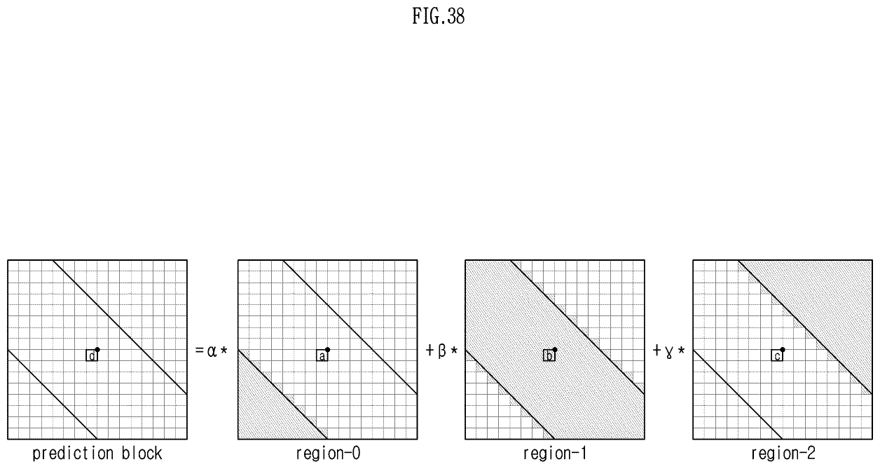

As shown in FIG. 38, a prediction block may be generated by using a weight defined for each prediction region of each region. The sum of weights applied to prediction regions may be a specific integer value.

In order to blend region-0, region-1 and region-2, the weights (α, β, γ) of region-0, region-1 and region-2 may be defined. A weight value may have a different value according to the position of a pixel. The sum of α, β and γ may have the same integer value at all pixel positions.

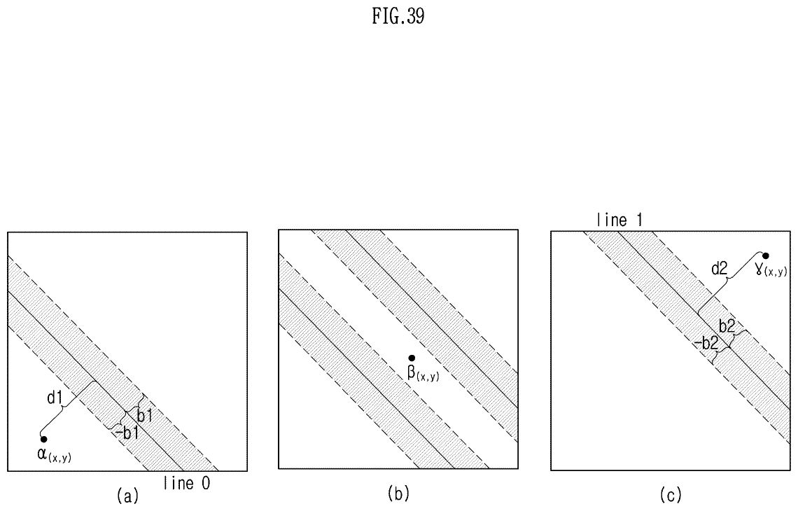

A weight value may be derived based on the position of a pixel to be blended and straight lines. An example in which a weight value is derived is shown in FIG. 39. FIG. 39(a) shows a method for deriving weight u applied to the first prediction region based on a distance (d1) between a pixel and straight line line 0 and a range (b1) to be blended. FIG. 39(c) shows a method for deriving weight γ applied to the third prediction region based on a distance (d2) between a pixel and straight line line 1 and a range (b2) to be blended. FIG. 39(b) shows a method for deriving weight β applied to the second prediction region based on predetermined values C, α and γ. C may be the maximum value of a weight.

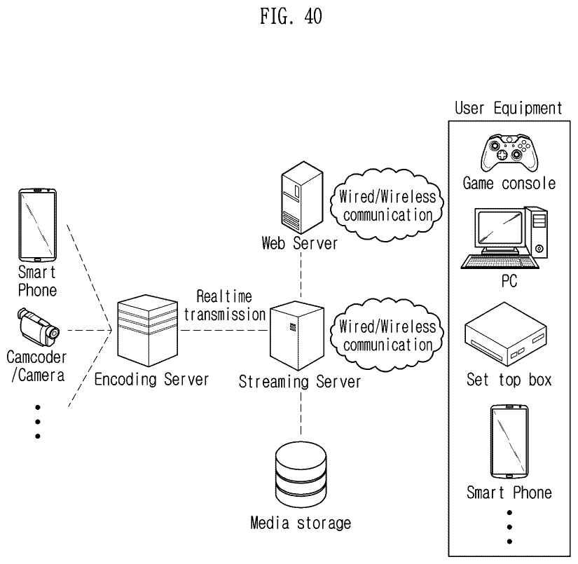

FIG. 40 shows an exemplary diagram of a content streaming system to which an embodiment of the present disclosure may be applied.

As shown in FIG. 40, the content streaming system to which an embodiment of the present disclosure is applied may broadly include an encoding server, a streaming server, a web server, a media storage, a user device, and a multimedia input device.

The encoding server compresses content input from multimedia input devices such as a smartphone, camera, or camcorder into digital data, generating a bitstream and transmitting it to the streaming server. As another example, when multimedia input devices such as a smartphone, camera, or camcorder directly generate a bitstream, the encoding server may be omitted.

The bitstream may be generated by the image encoding method and/or the image encoding apparatus to which an embodiment of the present disclosure is applied, and the streaming server may temporarily store the bitstream during the process of transmitting or receiving the bitstream.

The streaming server may transmit multimedia data to a user device based on a user request through the web server, and the web server may serve as an intermediary that informs user of available service. When a user requests a desired service from the web server, the web server may send the request to the streaming server, and the streaming server may transmit the multimedia data to the user. In this case, the content streaming system may include a separate control server, and in this case, a control server may function to control command/response exchanges between devices within the content streaming system.

The streaming server may receive content from a media storage and/or an encoding server. For example, when receiving content from the encoding server, the content may be received in real time. In this case, to provide a seamless streaming service, the streaming server may store the bitstream for a certain period of time.

Examples of the user device may include a mobile phone, a smartphone, a laptop computer, a digital broadcasting terminal, a personal digital assistant (PDA), a portable multimedia player (PMP), a navigation device, a slate PC, a tablet PC, an ultrabook, a wearable device (i.e., a smartwatch, a smart glass, a head-mounted display (HMD)), a digital TV, a desktop computer, and digital signage.

Each server within the content streaming system may be operated as a distributed server, in which case the data received by each server may be processed in a distributed manner.

The range of the present disclosure includes software or machine-executable instructions (i.e., an operating system, an application, firmware, a program, etc.) that enable operations according to the methods of various embodiments to be executed on a device or computer, and a non-transitory computer-readable medium in which such software or instructions are stored and executable on a device or computer.

The embodiments of the present disclosure may be used for encoding/decoding an image.

1. An image decoding method performed by an image decoding apparatus, comprising:
partitioning a current block into three regions based on partition information;
based on information for prediction of the three regions, generating a prediction region for the each region; and
based on the generated prediction regions, generating a prediction block for the current block.

2. The method of claim 1, wherein based on application information obtained from a bitstream representing that a mode partitioning a block into three regions is applied, the partition information is obtained from the bitstream, and
wherein based on allowance information obtained from the bitstream representing that the mode is allowed, the application information is obtained from the bitstream.

3. The method of claim 1, wherein the partition information includes a partition index representing any one of partition structure candidates that can be used to partition the current block, and
wherein the current block is partitioned into the three regions based on a partition structure candidate represented by the partition index among the partition structure candidates.

4. The method of claim 3, wherein the each partition structure candidate includes a partition angle index and a partition position index, and
wherein the current block is partitioned into the three regions based on a partition angle index and a partition position index represented by the partition index.

5. The method of claim 3, wherein the each partition structure candidate includes ternary information representing whether a ternary partition is performed, and
wherein the current block is partitioned into the three regions based on ternary information represented by the partition index representing that the ternary partition is performed, and is partitioned into two regions based on the ternary information the partition index representing that the ternary partition is not performed.

6. The method of claim 5, wherein the each partition structure candidate further includes a partition angle index and a distance index,
wherein the current block is partitioned into the three regions based on a first straight line and a second straight line,
wherein the first straight line is derived based on a partition angle index and a distance index represented by the partition index, and
wherein the second straight line is derived based on the partition angle index, the distance index and a predetermined distance represented by the partition index.

7. The method of claim 3, wherein the partition structure candidates include binary partition structure candidates and ternary partition structure candidates, and
wherein the current block is partitioned into the three regions based on the partition index representing any one of the ternary partition structure candidates, and is partitioned into two regions based on the partition index representing any one of the binary partition structure candidates.

8. The method of claim 1, wherein the information for the prediction includes prediction mode information representing a prediction mode of the each region, and
wherein the prediction mode information represents any one of an intra mode, an inter mode and an intra block copy (IBC) mode.

9. The method of claim 8, wherein the information for the prediction further includes prediction information on a prediction mode represented by the prediction mode information, and
wherein the prediction information is an index representing any one of available prediction candidates.

10. The method of claim 1, wherein the final prediction block is generated based on a value obtained by weighted averaging a first prediction region and a second prediction region with a first weight, and a value obtained by weighted averaging the second prediction region and a third prediction region with a second weight,
wherein the first weight is derived based on a first straight line partitioning the first prediction region and the second prediction region, and
wherein the second weight is derived based on a second straight line partitioning the second prediction region and the third prediction region.

11. The method of claim 1, wherein the final prediction block is generated based on a value obtained by applying a first weight to a first prediction region, a value obtained by applying a second weight to a second prediction region, and a value obtained by applying a third weight to a third prediction region,
wherein the first weight is derived based on a first straight line partitioning the first prediction region and the second prediction region,
wherein the third weight is derived based on a second straight line partitioning the second prediction region and the third prediction region, and
wherein the second weight is derived based on the first weight and the third weight.

12. The method of claim 1, wherein the information for the prediction is stored in a memory.

13. An image encoding method performed by an image encoding apparatus, comprising:
partitioning a current block into three regions;
based on information for a prediction of the three regions, generating a prediction region for the each region; and
based on the generated prediction regions, generating a prediction block for the current block.

14. A method for transmitting a bitstream generated by an image encoding method, the image encoding method comprising:
partitioning a current block into three regions;
based on information for a prediction of the three regions, generating a prediction region for the each region; and
based on the generated prediction regions, generating a prediction block for the current block.

15. A recording medium storing a bitstream generated by the image encoding method in claim 13.
